(19) United States
(12) Patent Application Publication
(10) Pub. No.: US 2026/0036797 A1
(43) Pub. Date: Feb. 5, 2026

(54) OPTICAL SYSTEM

(71) Applicant: ZHEJIANG SUNNY OPTICS CO., LTD., Yuyao City (CN)

(72) Inventors: Huan LIU, Yuyao City (CN); Xiaobin ZHANG, Yuyao City (CN); Lin HUANG, Yuyao City (CN); Yinfang JIN, Yuyao City (CN); Liefeng ZHAO, Yuyao City (CN)

(73) Assignee: ZHEJIANG SUNNY OPTICS CO., LTD., Yuyao City (CN)

(21) Appl. No.: 19/273,391

(22) Filed: Jul. 18, 2025

(30) Foreign Application Priority Data
Aug. 2, 2024 (CN) 202411057725.4

(51) Int. Cl. G02B 17/08; G02B 27/28

(52) U.S. Cl. CPC G02B 17/0856; G02B 27/28

(57) ABSTRACT

An optical system is disclosed, which sequentially comprises along an optical axis from a first side to a second side: a first lens, a reflective polarizing element, a first quarter-wave plate, a second lens, a third lens, a partially reflective element, a fourth lens, a second quarter-wave plate, and a polarizer; wherein the first lens has positive refractive power, and its first side surface is a convex surface and its second side surface is a concave surface; the second lens has positive refractive power, and its first side surface is a plane and its second side surface is a convex surface; the third lens has negative refractive power, and its first side surface is a concave surface; the second side surface of the fourth lens is a plane; wherein the number of lenses with refractive power in the optical system is four, and it is satisfied: 0.4<fz1/|R1+R4|<1.2.

### CROSS-REFERENCE TO RELATED APPLICATIONS

The present application claims priority to and benefit of China patent application No. 202411057725.4, filed on Aug. 2, 2024, which is hereby incorporated by reference in its entirety.

### TECHNICAL FIELD

The present application relates to the field of optical devices, and more specifically relates to a catadioptric optical system.

### BACKGROUND

Optical systems for virtual reality devices are mainly divided into three types: optical systems using aspherical lenses, optical systems using Fresnel lenses, and catadioptric optical systems. Among these, catadioptric optical systems are a major innovation in optical systems themselves and reserve space for the overall design of virtual reality devices, having become the mainstream trend in research and development.

Catadioptric optical systems shorten the physical length of the optical system by folding the optical path, thereby shifting the center of gravity of the virtual reality device backward and enhancing the user's experience. However, existing catadioptric optical systems typically employ two lenses, which results in a relatively blurry image for the catadioptric optical system and poor imaging quality.

### SUMMARY

The present application provides an optical system capable of at least solving or partially solving at least one or other problems existing in the prior art.

In an aspect, the present application provides an optical system, which sequentially comprises along an optical axis from a first side to a second side: a first lens, a second lens, a third lens, and a fourth lens; wherein the first lens has positive refractive power, and its first side surface is a convex surface and its second side surface is a concave surface; the second lens has positive refractive power, and its first side surface is a plane and its second side surface is a convex surface; the third lens has negative refractive power, and its first side surface is a concave surface; the fourth lens has refractive power, and its second side surface is a plane. Wherein, the optical system further comprises: a first quarter-wave plate, a reflective polarizing element, a partially reflective element, a second quarter-wave plate, and a polarizer; the first quarter-wave plate is arranged on the first side surface of the second lens; the reflective polarizing element is arranged on the first side surface of the first quarter-wave plate; the partially reflective element is arranged on the second side surface of the third lens; the second quarter-wave plate is arranged on the second side surface of the fourth lens; and the polarizer is arranged on the second side surface of the second quarter-wave plate. The number of lenses with refractive power in the optical system is four. The effective focal length f1 of the first lens and the effective focal length f2 of the second lens satisfy: 0.2<f1/f2≤0.5; the combined focal length fz1 of the first lens, the reflective polarizing element, the first quarter-wave plate and the second lens, the radius of curvature R1 of the first side surface of the first lens, and the radius of curvature R4 of the second side surface of the second lens satisfy: 0.4<fz1/|R1+R4|<1.2.

According to an exemplary embodiment of the present application, the radius of curvature R5 of the first side surface of the third lens and the effective focal length f3 of the third lens satisfy: 0.2<R5/f3≤0.8.

According to an exemplary embodiment of the present application, the center thickness CT1 of the first lens on the optical axis, the center thickness CTR of the reflective polarizing element on the optical axis, the center thickness CTQ1 of the first quarter-wave plate on the optical axis, and the center thickness CT2 of the second lens on the optical axis satisfy: 0.5<(CT2+CTR+CTQ1)/CT1<0.9.

According to an exemplary embodiment of the present application, the effective focal length f4 of the fourth lens and the combined focal length fz2 of the third lens, the fourth lens, the second quarter-wave plate and the polarizer satisfy: 0.4<f4/fz2<1.6.

According to an exemplary embodiment of the present application, the Abbe number V1 of the first lens and the refractive index N1 of the first lens satisfy: 37.5<V1/N1<47.3.

According to an exemplary embodiment of the present application, the radius of curvature R7 of the first side surface of the fourth lens and the effective focal length f4 of the fourth lens satisfy: 0.5<R7/f4<0.9.

According to an exemplary embodiment of the present application, the axial distance SAG11 from the intersection of the first side surface of the first lens and the optical axis to the effective semi-aperture vertex of the first side surface of the first lens, the axial distance SAG12 from the intersection of the second side surface of the first lens and the optical axis to the effective semi-aperture vertex of the second side surface of the first lens, and the radius of curvature R1 of the first side surface of the first lens satisfy: 2.7<R1/(SAG11+SAG12)<3.7.

According to an exemplary embodiment of the present application, the axial distance SAG41 from the intersection of the first side surface of the fourth lens and the optical axis to the effective semi-aperture vertex of the first side surface of the fourth lens and the center thickness CT4 of the fourth lens on the optical axis satisfy: 0.3<|SAG41|/CT4<0.7.

According to an exemplary embodiment of the present application, the center thickness CT3 of the third lens on the optical axis and the edge thickness ET3 of the third lens satisfy: 0.7<CT3/ET3<1.0.

According to an exemplary embodiment of the present application, the axial distance TD from the first side surface of the first lens to the second side surface of the fourth lens, the total effective focal length f of the optical system, and the maximum field of view FOV of the optical system satisfy: 1.8<TD/(f×tan(FOV))<2.0.

According to an exemplary embodiment of the present application, an imaging surface is provided on the second side of the optical system, and the axial distance TTL from the first side surface of the first lens to the imaging surface and the total effective focal length f of the optical system satisfy: 0.6<TTL/f<0.7.

According to an exemplary embodiment of the present application, an imaging surface is provided on the second side of the optical system, and the axial distance BFL from the second side surface of the fourth lens to the imaging surface, the center thickness CTQ2 of the second quarter-wave plate on the optical axis, and the center thickness CTL of the polarizer on the optical axis satisfy: 8.2<BFL/(CTQ2+CTL)<9.1.

According to an exemplary embodiment of the present application, the sum of the center thicknesses ΣCT of the first lens, the second lens, the third lens, and the fourth lens on the optical axis and the entrance pupil diameter EPD of the optical system satisfy: 0.3<ΣCT/EPD<1.0.

According to an exemplary embodiment of the present application, the total effective focal length f of the optical system and the radius of curvature R2 of the second side surface of the first lens satisfy: 0.2<f/R2<1.2.

The optical system provided by the present application employs four lenses, reasonably configures the refractive power of the four lenses, and enables the optical system to satisfy “0.2<f1/f2≤0.5”, which is beneficial for improving the imaging quality of the optical system; simultaneously, by limiting the ratio of the combined focal length of the first lens, the reflective polarizing element, the first quarter-wave plate, and the second lens to the sum of the radii of curvature of the first side surface of the first lens and the second side surface of the second lens, it is beneficial for providing a wider field of view, allowing users to see more display content (e.g., virtual reality information or augmented reality information), enhancing user immersion and experience, and can also reduce or eliminate optical problems such as distortion and aberration, thereby improving the clarity and accuracy of images formed by the optical system.

### BRIEF DESCRIPTION OF THE DRAWINGS

Other features, objectives, and advantages of the present application will become more apparent by reading the detailed description of non-limiting embodiments with reference to the following accompanying drawings.

FIG. 1 shows a schematic structural diagram of an optical system according to Embodiment 1 of the present application;

FIGS. 2A to 2C respectively show a longitudinal aberration curve, an astigmatism curve, and a distortion curve of an optical system according to Embodiment 1 of the present application;

FIG. 3 shows a Modulation Transfer Function (MTF) curve of an optical system according to Embodiment 1 of the present application;

FIG. 4 shows a schematic structural diagram of an optical system according to Embodiment 2 of the present application;

FIGS. 5A to 5C respectively show a longitudinal aberration curve, an astigmatism curve, and a distortion curve of an optical system according to Embodiment 2 of the present application;

FIG. 6 shows a Modulation Transfer Function curve of an optical system according to Embodiment 2 of the present application;

FIG. 7 shows a schematic structural diagram of an optical system according to Embodiment 3 of the present application;

FIGS. 8A to 8C respectively show a longitudinal aberration curve, an astigmatism curve, and a distortion curve of an optical system according to Embodiment 3 of the present application;

FIG. 9 shows a Modulation Transfer Function curve of an optical system according to Embodiment 3 of the present application;

FIG. 10 shows a schematic structural diagram of an optical system according to Embodiment 4 of the present application;

FIGS. 11A to 11C respectively show a longitudinal aberration curve, an astigmatism curve, and a distortion curve of an optical system according to Embodiment 4 of the present application;

FIG. 12 shows a Modulation Transfer Function curve of an optical system according to Embodiment 4 of the present application;

FIG. 13 shows a schematic structural diagram of an optical system according to Embodiment 5 of the present application;

FIGS. 14A to 14C respectively show a longitudinal aberration curve, an astigmatism curve, and a distortion curve of an optical system according to Embodiment 5 of the present application; and

FIG. 15 shows a Modulation Transfer Function curve of an optical system according to Embodiment 5 of the present application.

### DETAILED DESCRIPTION OF EMBODIMENTS

For a better understanding of the present application, various aspects of the present application will be described in more detail with reference to the accompanying drawings. It should be understood that these detailed descriptions are merely descriptions of exemplary embodiments of the present application and are not intended to limit the scope of the present application in any way. Throughout the entire specification, the same reference numerals refer to the same elements.

It should be noted that, in this specification, expressions such as “first”, “second”, etc. are used merely to distinguish one feature from another and do not indicate any limitation on the features. Therefore, without departing from the teachings of the present application, a first lens discussed below may also be referred to as a second lens.

In the accompanying drawings, for ease of illustration, the thickness, size, and shape of the lenses have been slightly exaggerated. Specifically, the spherical or aspherical shapes shown in the accompanying drawings are shown by way of example. That is, the spherical or aspherical shapes are not limited to those shown in the accompanying drawings. The accompanying drawings are for illustration only and are not drawn strictly to scale.

As used herein, the paraxial region refers to the region near the optical axis. If a lens surface is a convex surface and the position of the convex surface is not defined, it indicates that the lens surface is at least convex in the paraxial region; if a lens surface is a concave surface and the position of the concave surface is not defined, it indicates that the lens surface is at least concave in the paraxial region. The surface of each lens closest to the first side (e.g., the human eye side) is referred to as the first side surface of the lens, and the surface of each lens closest to the second side (e.g., the display screen side) is referred to as the second side surface of the lens.

It should also be understood that the terms “comprises”, “comprising”, “has”, “having”, “includes”, “including”, and/or “containing”, when used in this specification, indicate the presence of the stated features, elements, and/or components, but do not preclude the presence or addition of one or more other features, elements, components, and/or combinations thereof. Furthermore, when describing embodiments of the present application, the use of “may” indicates “one or more embodiments of the present application”. And, the term “exemplary” is intended to mean an example or illustration.

Unless otherwise defined, all terms used herein (including technical and scientific terms) have the same meaning as commonly understood by one of ordinary skill in the art to which this application pertains. It should also be understood that terms (e.g., those defined in commonly used dictionaries) should be interpreted as having a meaning consistent with their meaning in the context of the relevant art, and will not be interpreted in an idealized or overly formal sense unless expressly defined otherwise herein.

It should be noted that, in the absence of conflict, the embodiments and features in the embodiments of the present application can be combined with each other. The present application will now be described in detail with reference to the accompanying drawings and in conjunction with embodiments.

The features, principles, and other aspects of the present application are described in detail below.

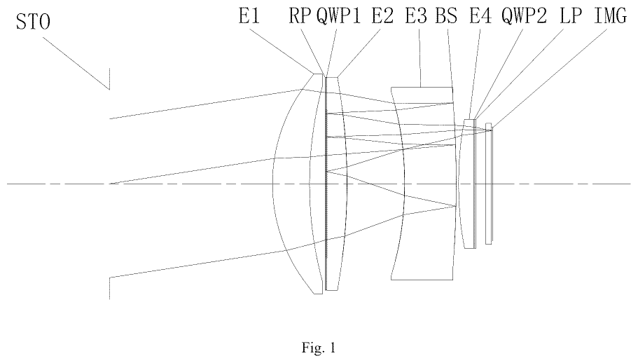

Referring to FIGS. 1, 4, 7, 10, and 13, a first aspect of the present application provides an optical system, which may comprise, arranged sequentially along an optical axis from a first side to a second side, a first lens, a second lens, a third lens, and a fourth lens.

In an exemplary embodiment, the first lens may have positive refractive power. The second lens may have positive refractive power. The third lens may have negative refractive power. The fourth lens may have positive or negative refractive power. Reasonably configuring the refractive power of each lens is beneficial for improving the imaging quality of the optical system.

In an exemplary embodiment, the first side surface of the first lens is a convex surface, and the second side surface is a concave surface.

In an exemplary embodiment, the first side surface of the second lens is a plane, and the second side surface is a convex surface.

In an exemplary embodiment, the first side surface of the third lens is a concave surface, and the second side surface is a convex surface or a concave surface.

In an exemplary embodiment, the first side surface of the fourth lens is a convex surface or a concave surface, and the second side surface is a plane.

In an exemplary embodiment, the optical system may further comprise a reflective polarizing element and a first quarter-wave plate. The first quarter-wave plate may be arranged on the first side surface of the second lens. The reflective polarizing element may be arranged on the first side surface of the first quarter-wave plate.

In an exemplary embodiment, the first side surface of the second lens is a plane. The reflective polarizing element and the first quarter-wave plate are attached to the first side surface of the second lens, wherein, compared to the reflective polarizing element, the first quarter-wave plate is closer to the second lens. By compounding the reflective polarizing element and the first quarter-wave plate together and then attaching them to the first side plane of the second lens, the difficulty of the attachment process can be reduced, the attachment quality can be improved, and thus the performance of the optical system can be enhanced.

In an exemplary embodiment, the optical system may further comprise a partially reflective element. The partially reflective element may be arranged on the second side surface of the third lens. The partially reflective element has a semi-transmissive and semi-reflective effect on light. By arranging the partially reflective element on the second side surface of the third lens, and combining it with the reflective polarizing element and the first quarter-wave plate, light can be reflected and refracted multiple times, effectively reducing the physical length of the optical system.

In an exemplary embodiment, the optical system may further comprise a second quarter-wave plate and a polarizer. The second quarter-wave plate may be arranged on the second side surface of the fourth lens. The polarizer may be arranged on the second side surface of the second quarter-wave plate. The polarizer is used to convert natural light emitted from the display screen on the second side into linearly polarized light, and the second quarter-wave plate is used to convert the linearly polarized light from the polarizer into circularly polarized light. By utilizing the second quarter-wave plate and the polarizer, natural light emitted from the display screen can be converted into circularly polarized light, thereby reducing the influence of material stress on the elements between the display screen and the polarizer, and improving the contrast of the optical system.

In an exemplary embodiment, the second side surface of the fourth lens is a plane. The second quarter-wave plate and the polarizer are attached to the second side surface of the fourth lens, wherein, compared to the polarizer, the second quarter-wave plate is closer to the fourth lens. By compounding the second quarter-wave plate and the polarizer together and then attaching them to the second side plane of the fourth lens, the difficulty of the attachment process can be reduced, the attachment quality can be improved, and thus the performance of the optical system can be enhanced.

In an exemplary embodiment, the optical system may further comprise an aperture stop, which is arranged between the first side and the first lens. Image light from the second side passes through the polarizer, the second quarter-wave plate, the fourth lens, the third lens, the second lens, the first quarter-wave plate, the reflective polarizing element, the first lens, etc., undergoes multiple refractions and reflections, and is finally projected into the eye of the user on the first side.

In an exemplary embodiment, the first side may be, for example, the human eye side, and the second side may be, for example, the display screen side. Accordingly, the first side surface of each element (the first lens, the second lens, the third lens, the fourth lens, the first quarter-wave plate, the second quarter-wave plate) may be referred to as the near-human eye side surface, and the second side surface may be referred to as the near-screen side surface.

In an exemplary embodiment, an imaging surface may be provided on the second side of the optical system. The imaging surface may be provided with a display screen. Image light from the display screen may sequentially pass through the polarizer, the second quarter-wave plate, the fourth lens, the third lens, the second lens, the first quarter-wave plate, and reach the reflective polarizing element, where it is reflected to form a first reflected image light. The first reflected image light passes through the first quarter-wave plate, the second lens, the third lens, and reaches the partially reflective element on the second side surface of the third lens, where it is reflected to form a second reflected image light. The second reflected image light sequentially passes through the third lens, the second lens, the first quarter-wave plate, the reflective polarizing element, the first lens, and reaches the aperture stop, and is finally projected into the eye of the user. The optical system provided by the present application folds the required optical path by combining light reflection and refraction without affecting projection quality, effectively shortening the physical length of the optical system.

In an exemplary embodiment, the effective focal length f1 of the first lens and the effective focal length f2 of the second lens may satisfy: 0.2<f1/f2<0.5; the combined focal length fz1 of the first lens, the reflective polarizing element, the first quarter-wave plate and the second lens, the radius of curvature R1 of the first side surface of the first lens, and the radius of curvature R4 of the second side surface of the second lens may satisfy: 0.4<fz1/|R1+R4|<1.2. By controlling the optical system to satisfy “0.2<f1/f2<0.5”, it is beneficial for improving the imaging quality of the optical system; simultaneously, by limiting the ratio of the combined focal length of the first lens, the reflective polarizing element, the first quarter-wave plate, and the second lens to the sum of the radii of curvature of the first side surface of the first lens and the second side surface of the second lens, it is beneficial for providing a wider field of view, allowing users to see more display content (e.g., virtual reality information or augmented reality information), enhancing user immersion and experience, and can also reduce or eliminate problems such as distortion and aberration, thereby improving the clarity and accuracy of images formed by the optical system.

In an exemplary embodiment, the radius of curvature R5 of the first side surface of the third lens and the effective focal length f3 of the third lens may satisfy: 0.2<R5/f3≤0.8. By controlling the ratio of the radius of curvature of the first side surface of the third lens to the effective focal length of the third lens, the shape of the third lens can be constrained, ensuring that the refraction and focusing effects of light inside the third lens meet the requirements, and making the propagation of light inside the third lens more reasonable and effective.

In an exemplary embodiment, the center thickness CT1 of the first lens on the optical axis, the center thickness CTR of the reflective polarizing element on the optical axis, the center thickness CTQ1 of the first quarter-wave plate on the optical axis, and the center thickness CT2 of the second lens on the optical axis may satisfy: 0.5<(CT2+CTR+CTQ1)/CT1<0.9. By controlling the ratio of the sum of the center thicknesses of the reflective polarizing element, the first quarter-wave plate, and the second lens to the center thickness of the first lens, the physical length of the optical system can be constrained within a reasonable range, and it is also beneficial for the attachment of the reflective polarizing element and the first quarter-wave plate.

In an exemplary embodiment, the effective focal length f4 of the fourth lens and the combined focal length fz2 of the third lens, the fourth lens, the second quarter-wave plate and the polarizer may satisfy: 0.4<f4/fz2<1.6. By controlling the ratio of the effective focal length of the fourth lens to the combined focal length of the third lens, the fourth lens, the second quarter-wave plate, and the polarizer, it is beneficial for reasonably distributing the focal lengths of the third lens and the fourth lens, thereby ensuring that the focusing and transmission effects of light within the optical system meet the requirements.

In an exemplary embodiment, the Abbe number V1 of the first lens and the refractive index N1 of the first lens may satisfy: 37.5<V1/N1<47.3. By controlling the ratio of the Abbe number to the refractive index of the first lens, the influence of dispersion on the image formed by the optical system can be reduced, improving the color accuracy and consistency of the optical system, and also enabling the optical system to cover a wider spectral range to meet application requirements for different wavelengths.

In an exemplary embodiment, the radius of curvature R7 of the first side surface of the fourth lens and the effective focal length f4 of the fourth lens may satisfy: 0.5<R7/f4<0.9. By controlling the ratio of the radius of curvature of the first side surface of the fourth lens to the effective focal length of the fourth lens, the shape of the fourth lens can be constrained, ensuring that the refraction and focusing effects of light inside the fourth lens meet the requirements, and also reducing the sensitivity of the optical system to lens shape changes, improving the performance and stability of the optical system.

In an exemplary embodiment, the axial distance SAG11 from the intersection of the first side surface of the first lens and the optical axis to the effective semi-aperture vertex of the first side surface of the first lens, the axial distance SAG12 from the intersection of the second side surface of the first lens and the optical axis to the effective semi-aperture vertex of the second side surface of the first lens, and the radius of curvature R1 of the first side surface of the first lens may satisfy: 2.7<R1/(SAG11+SAG12)<3.7. By controlling the above condition, the radius of curvature of the first side surface of the first lens and the sagittal heights of the first and second side surfaces of the first lens can be constrained, thereby limiting the surface shape of the first lens, making the refraction and focusing effects of light on the surface of the first lens more compliant with requirements.

In an exemplary embodiment, the axial distance SAG41 from the intersection of the first side surface of the fourth lens and the optical axis to the effective semi-aperture vertex of the first side surface of the fourth lens and the center thickness CT4 of the fourth lens on the optical axis may satisfy: 0.3<|SAG41|/CT4<0.7. By controlling the above condition, the shape of the fourth lens can be constrained, making the refraction and focusing effects of light on the surface of the fourth lens more compliant with requirements, and also helping to improve the imaging quality of the optical system and reduce the difficulty of forming the fourth lens.

In an exemplary embodiment, the center thickness CT3 of the third lens on the optical axis and the edge thickness ET3 of the third lens may satisfy: 0.7<CT3/ET3<1.0. By controlling the ratio of the center thickness to the edge thickness of the third lens, the uniform distribution of the thickness of the third lens at different positions can be ensured, reducing the influence of thickness non-uniformity of the third lens on the imaging quality of the optical system, and also helping to improve the molding yield of the third lens.

In an exemplary embodiment, the axial distance TD from the first side surface of the first lens to the second side surface of the fourth lens, the total effective focal length f of the optical system, and the maximum field of view FOV of the optical system satisfy: 1.8<TD/(f×tan(FOV))<2.0.

By controlling the above condition, the maximum field of view, the total effective focal length, and the axial distance from the first side surface of the first lens to the second side surface of the fourth lens of the optical system can be constrained, ensuring that the propagation and focusing effects of light within the optical system meet the requirements, and also reducing the sensitivity of the optical system to changes in total effective focal length and field of view, thereby improving the performance and stability of the optical system.

In an exemplary embodiment, the axial distance TTL from the first side surface of the first lens to the imaging surface and the total effective focal length f of the optical system may satisfy: 0.6<TTL/f<0.7. By constraining the ratio of the axial distance from the first side surface of the first lens to the imaging surface to the total effective focal length of the optical system within a reasonable range, a compact design of the optical system can be achieved, reducing the volume and weight of the optical system; it also facilitates the focusing and transmission of light, thereby ensuring that the optical system achieves good imaging performance.

In an exemplary embodiment, the axial distance BFL from the second side surface of the fourth lens to the imaging surface, the center thickness CTQ2 of the second quarter-wave plate on the optical axis, and the center thickness CTL of the polarizer on the optical axis may satisfy: 8.2<BFL/(CTQ2+CTL)<9.1. By controlling the ratio of the axial distance from the second side surface of the fourth lens to the imaging surface to the sum of the center thicknesses of the second quarter-wave plate and the polarizer, the total effective focal length of the optical system can be indirectly constrained, enabling the optical system to provide clear imaging within the expected working distance range; it can also indirectly constrain the air intervals between lenses, which is beneficial for achieving a thinner and lighter optical system.

In an exemplary embodiment, the sum of the center thicknesses ΣCT of the first lens, the second lens, the third lens, and the fourth lens on the optical axis and the entrance pupil diameter EPD of the optical system may satisfy: 0.3<ΣCT/EPD<1.0. By controlling the ratio of the sum of the center thicknesses of the first lens, the second lens, the third lens, and the fourth lens to the entrance pupil diameter of the optical system, a compact design of the optical system can be achieved, reducing the volume and size of the optical system; it also helps to reduce the sensitivity of the optical system to thickness changes and incident light changes, thereby improving the performance and stability of the optical system.

In an exemplary embodiment, the total effective focal length f of the optical system and the radius of curvature R2 of the second side surface of the first lens may satisfy: 0.2<f/R2<1.2. By controlling the ratio of the total effective focal length of the optical system to the radius of curvature of the second side surface of the first lens, aberrations and distortions can be reduced, improving the clarity, contrast, and accuracy of images formed by the optical system; it also facilitates the focusing and transmission of light, thereby ensuring that the optical system achieves good imaging performance.

The optical system according to the above embodiments of the present application may employ multiple lenses, such as the four lenses described above. By reasonably distributing the parameters of the reflective polarizing element, the first quarter-wave plate, the second quarter-wave plate, the polarizer, and each lens, the physical length of the optical system can be shortened, the imaging quality of the optical system can be improved, and user immersion and experience can be enhanced. The optical system configured as described above features miniaturization and good imaging quality, among other characteristics, and can well meet the usage requirements of various portable electronic products in projection scenarios.

In an embodiment of the present application, at least one of the surfaces of the second lens, the third lens, and the fourth lens is an aspherical surface. The characteristics of aspherical lenses are that the curvature continuously changes from the center of the lens to its periphery. Unlike spherical lenses, which have a constant curvature from the center to the periphery, aspherical lenses have better curvature radius characteristics, with the advantages of improving distortion aberration and improving astigmatic aberration. By employing aspherical lenses, aberrations that occur during imaging can be eliminated as much as possible, thereby improving imaging quality.

A second aspect of the present application provides an optical system, which comprises, arranged sequentially along an optical axis from a first side to a second side, a first lens, a second lens, a third lens, and a fourth lens. The first lens has positive refractive power, and its first side surface is a convex surface and its second side surface is a concave surface. The second lens has positive refractive power, and its first side surface is a plane and its second side surface is a convex surface. The third lens has negative refractive power, and its first side surface is a concave surface.

The fourth lens has refractive power, and its second side surface is a plane. The optical system further comprises a first quarter-wave plate, a reflective polarizing element, a partially reflective element, a second quarter-wave plate, and a polarizer. The first quarter-wave plate is arranged on the first side surface of the second lens. The reflective polarizing element is arranged on the first side surface of the first quarter-wave plate. The partially reflective element is arranged on the second side surface of the third lens. The second quarter-wave plate is arranged on the second side surface of the fourth lens. The polarizer is arranged on the second side surface of the second quarter-wave plate.

Wherein, the effective focal length f1 of the first lens and the effective focal length f2 of the second lens may satisfy: 0.2<f1/f2<0.5. The axial distance BFL from the second side surface of the fourth lens to the imaging surface, the center thickness CTQ2 of the second quarter-wave plate on the optical axis, and the center thickness CTL of the polarizer on the optical axis may satisfy: 8.2<BFL/(CTQ2+CTL)<9.1. The optical system provided by the present application employs four lenses, reasonably configures the refractive power of the four lenses, and enables the optical system to satisfy “0.2<f1/f2<0.5”, which is beneficial for improving the imaging quality of the optical system; simultaneously, by limiting the ratio of the axial distance from the second side surface of the fourth lens to the imaging surface to the sum of the center thicknesses of the second quarter-wave plate and the polarizer, the total effective focal length of the optical system can be indirectly constrained, enabling the optical system to provide clear imaging within the expected working distance range; it can also indirectly constrain the air intervals between lenses, which is beneficial for achieving a thinner and lighter optical system.

However, those skilled in the art should understand that the number of lenses constituting the optical system may be changed without departing from the technical solution claimed by the present application, so as to obtain the various results and advantages described in this specification.

Specific embodiments of the optical system applicable to the above-described embodiments are further described below with reference to the accompanying drawings.

### Embodiment 1

Hereinafter, an optical system according to Embodiment 1 of the present application will be described with reference to FIGS. 1, 2A to 2C, and 3.

As shown in FIG. 1, the optical system may comprise, arranged sequentially along an optical axis from a first side to a second side, a first lens E1, a reflective polarizing element RP, a first quarter-wave plate QWP1, a second lens E2, a third lens E3, a partially reflective element BS, a fourth lens E4, a second quarter-wave plate QWP2, and a polarizer LP. An aperture stop STO may be arranged between the first side and the first lens E1. In this embodiment, the first side refers to the human eye side, and the second side refers to the display screen side. The first side surface of each element is referred to as the near-human eye side surface, and the second side surface is referred to as the near-screen side surface.

The first lens E1 has positive refractive power, and its near-human eye side surface S1 is a convex surface, and its near-screen side surface S2 is a concave surface. The second lens E2 has positive refractive power, and its near-human eye side surface S3 is a plane, and its near-screen side surface S4 is a convex surface. The third lens E3 has negative refractive power, and its near-human eye side surface S5 is a concave surface, and its near-screen side surface S6 is a convex surface. The fourth lens E4 has positive refractive power, and its near-human eye side surface S7 is a convex surface, and its near-screen side surface S8 is a plane. The reflective polarizing element RP and the first quarter-wave plate QWP1 are attached to the near-human eye side surface S3 of the second lens E2. The partially reflective element BS is attached to the near-screen side surface S6 of the third lens E3. The second quarter-wave plate QWP2 and the polarizer LP are attached to the near-screen side surface S8 of the fourth lens E4.

In this example, an imaging surface IMG may be provided on the second side of the optical system, and the imaging surface IMG may, for example, be provided with a display screen. Image light from the imaging surface IMG sequentially passes through the polarizer LP, the second quarter-wave plate QWP2, the fourth lens E4, the third lens E3, the second lens E2, and the first quarter-wave plate QWP1, and reaches the reflective polarizing element RP, where a first reflection occurs at the reflective polarizing element RP. The light after the first reflection passes through the first quarter-wave plate QWP1, the second lens E2, and the third lens E3, and reaches the partially reflective element BS located on the near-screen side surface of the third lens E3, where a second reflection occurs at the partially reflective element BS. The light after the second reflection sequentially passes through the third lens E3, the second lens E2, the first quarter-wave plate QWP1, the reflective polarizing element R the first lens E1, and reaches the aperture stop, and is finally projected into the eye of the user. For example, the light rays from this optical system, after two reflections, are finally projected into the eye of the user A protective glass (not shown) may also be disposed between the imaging surface IMG and the polarizer LP.

Table 1 shows a basic parameter table of the optical system of Embodiment 1, wherein the units for radius of curvature and thickness/distance are all millimeters (mm). Image light from the imaging surface IMG passes through each element in the order from serial No. 23 to serial No. 1 and is finally projected into the human eye.

TABLE 1

| | | | | | Material | | | |
|---|---|---|---|---|---|---|---|---|
| | | Surface | Radius of | Thickness/ | Refractive | Abbe | Refraction/ | Cone |
| No. | Element | Type | Curvature | Distance | Index | Number | Reflection | coefficient |
| | | spherical | Infinity | −100000.0000 | | | Refraction | |
| 1 | Aperture Stop | spherical | Infinity | 20.0000 | | | Refraction | |
| 2 | First Lens | spherical | 20.1034 | 4.5470 | 1.555 | 63.37 | Refraction | |
| 3 | | spherical | 45.9099 | 1.9212 | | | Refraction | |
| 4 | Reflective polarizing | spherical | Infinity | 0.1100 | 1.502 | 57.00 | Refraction | |
| | element | | | | | | | |
| 5 | First quarter-wave plate | spherical | Infinity | 0.1100 | 1.502 | 57.00 | Refraction | |
| 6 | Second lens | spherical | Infinity | 2.4702 | 1.500 | 57.28 | Refraction | |
| 7 | | spherical | −71.8508 | 7.0665 | | | Refraction | |
| 8 | Third lens | aspherical | −44.6226 | 6.3361 | 1.694 | 31.18 | Refraction | 0.0000 |
| 9 | Partially reflective element | aspherical | −134.3209 | −6.3361 | 1.694 | 31.18 | Reflection | 0.0000 |
| 10 | | aspherical | −44.6226 | −7.0665 | | | Refraction | 0.0000 |
| 11 | | spherical | −71.8508 | −2.4702 | 1.500 | 57.28 | Refraction | |
| 12 | | spherical | Infinity | −0.1100 | 1.502 | 57.00 | Refraction | |
| 13 | Reflective polarizing | spherical | Infinity | 0.1100 | 1.502 | 57.00 | Reflection | |
| | element | | | | | | | |
| 14 | Second lens | spherical | Infinity | 2.4702 | 1.500 | 57.28 | Refraction | |
| 15 | | spherical | −71.8508 | 7.0665 | | | Refraction | |
| 16 | Third lens | aspherical | −44.6226 | 6.3361 | 1.694 | 31.18 | Refraction | 0.0000 |
| 17 | | aspherical | −134.3209 | 0.2999 | | | Refraction | 0.0000 |
| 18 | Fourth lens | aspherical | 52.7401 | 1.8790 | 1.855 | 23.83 | Refraction | 0.0000 |
| 19 | Second quarter-wave plate | spherical | Infinity | 0.1000 | 1.502 | 57.00 | Refraction | |
| 20 | Polarizer | spherical | Infinity | 0.1500 | 1.502 | 57.00 | Refraction | |
| 21 | | spherical | Infinity | 1.2000 | | | Refraction | |
| 22 | Protective glass | spherical | Infinity | 0.7100 | 1.519 | 64.17 | Refraction | |
| 23 | | spherical | Infinity | 0.1000 | | | Refraction | |
| | Imaging surface | spherical | Infinity | 0.0000 | | | Refraction | |

In this embodiment, the near-human eye side surface S5 and the near-screen side surface S6 of the third lens E3, and the near-human eye side surface S7 of the fourth lens E4 are all aspherical surfaces. The surface profile X of each aspherical lens can be defined by, but is not limited to, the following aspherical formula:

$$x = \frac{ch \text{?}}{1 + \sqrt{1 - ( k + 1 ) c \text{?} h \text{?}}} + \sum Ath \text{?} \qquad ( 1 )$$

$$\text{?} \text{indicates text missing or illegible when filed}$$

Wherein, X is the sagittal height of the aspherical surface, which is the distance from the aspherical vertex along the optical axis at a height h; c is the paraxial curvature of the aspherical surface, where c=1/R (i.e., the paraxial curvature c is the reciprocal of the radius of curvature R in Table 1 above); k is the cone coefficient; and Ai is the i-th order correction coefficient of the aspherical surface. Table 2 provides the higher-order coefficients A4, A6, A8, A10, A12, A14, A16, A18, and A20 for the aspherical surfaces S5-S7 used in Embodiment 1.

TABLE 2

| Surface | | | | | |
|---|---|---|---|---|---|
| Number | A4 | A6 | A8 | A10 | A12 |
| S5 | −4.6221E−01 | 8.8946E−02 | −5.5206E−02 | −1.3412E−02 | −5.1629E−03 |
| S6 | 2.6838E−01 | 1.6185E−01 | 5.1195E−02 | 2.7031E−02 | 9.7489E−03 |
| S7 | 1.1280E−01 | −9.6967E−03 | 3.3226E−04 | −1.9499E−04 | −1.4313E−04 |

| Surface | | | | |
|---|---|---|---|---|
| Number | A14 | A16 | A18 | A20 |
| S5 | −1.5918E−03 | −3.8536E−04 | 0.0000E+00 | 0.0000E+00 |
| S6 | 2.4221E−03 | 2.6929E−04 | 0.0000E+00 | 0.0000E+00 |
| S7 | 0.0000E+00 | 0.0000E+00 | 0.0000E+00 | 0.0000E+00 |

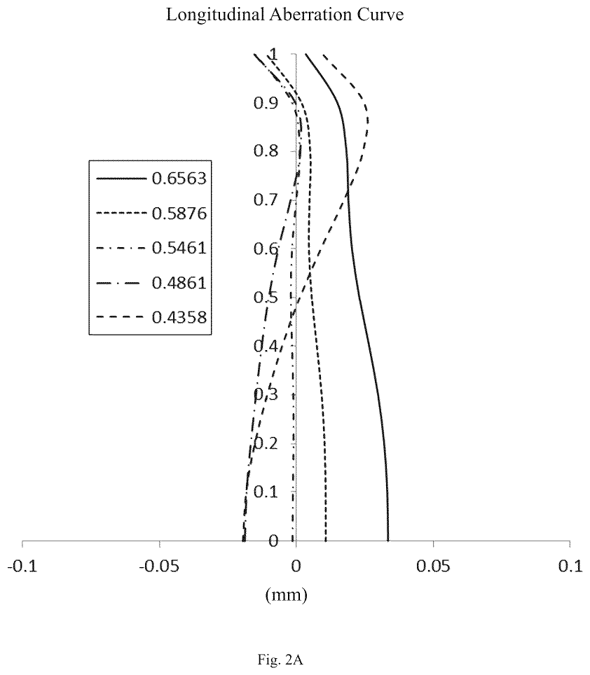

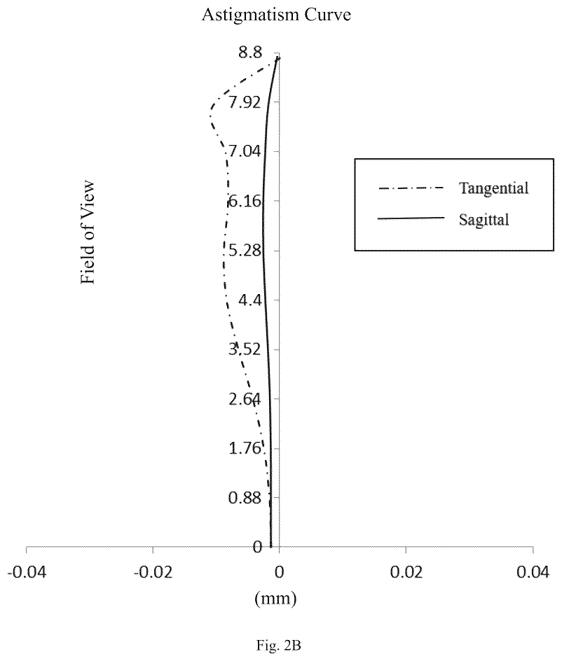

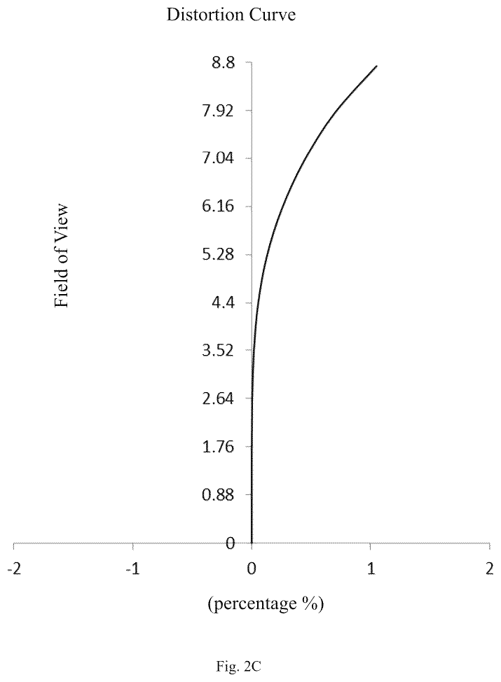

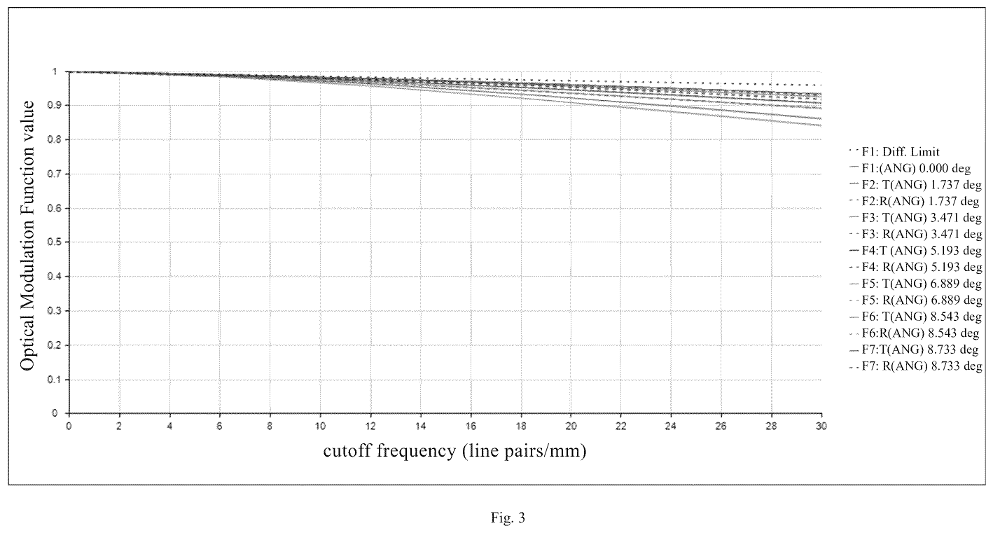

FIG. 2A shows a longitudinal aberration curve of the optical system of Embodiment 1, which represents the deviation of the converging point after light rays of different wavelengths pass through the optical system. FIG. 2B shows an astigmatism curve of the optical system of Embodiment 1, which represents the curvature of a tangential plane and the curvature of a sagittal plane corresponding to different field angles. FIG. 2C shows a distortion curve of the optical system of Embodiment 1, which represents the magnitude of distortion corresponding to different field angles. FIG. 3 shows a Modulation Transfer Function curve of the optical system of Embodiment 1. As can be seen from FIGS. 2A to 2C and FIG. 3, the optical system provided in Embodiment 1 can achieve good imaging quality.

### Embodiment 2

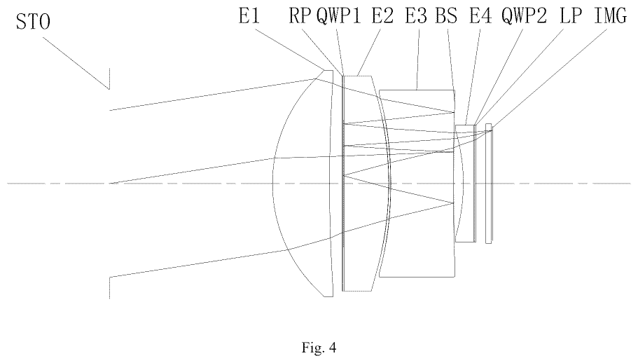

Hereinafter, an optical system according to Embodiment 2 of the present application will be described with reference to FIGS. 4, 5A to 5C, and 6.

As shown in FIG. 4, the optical system may comprise, arranged sequentially along an optical axis from a first side to a second side, a first lens E1, a reflective polarizing element RP, a first quarter-wave plate QWP1, a second lens E2, a third lens E3, a partially reflective element BS, a fourth lens E4, a second quarter-wave plate QWP2, and a polarizer LP. An aperture stop STO may be arranged between the first side and the first lens E1. In this embodiment, the first side refers to the human eye side, and the second side refers to the display screen side. The first side surface of each element is referred to as the near-human eye side surface, and the second side surface is referred to as the near-screen side surface.

The first lens E1 has positive refractive power, and its near-human eye side surface S1 is a convex surface, and its near-screen side surface S2 is a concave surface. The second lens E2 has positive refractive power, and its near-human eye side surface S3 is a plane, and its near-screen side surface S4 is a convex surface. The third lens E3 has negative refractive power, and its near-human eye side surface S5 is a concave surface, and its near-screen side surface S6 is a concave surface. The fourth lens E4 has negative refractive power, and its near-human eye side surface S7 is a concave surface, and its near-screen side surface S8 is a plane. The reflective polarizing element RP and the first quarter-wave plate QWP1 are attached to the near-human eye side surface S3 of the second lens E2. The partially reflective element BS is attached to the near-screen side surface S6 of the third lens E3. The second quarter-wave plate QWP2 and the polarizer LP are attached to the near-screen side surface S8 of the fourth lens E4.

In this example, an imaging surface IMG may be provided on the second side of the optical system, and the imaging surface IMG may, for example, be provided with a display screen. Image light from the imaging surface IMG sequentially passes through the polarizer LP, the second quarter-wave plate QWP2, the fourth lens E4, the third lens E3, the second lens E2, and the first quarter-wave plate QWP1, and reaches the reflective polarizing element RP, where a first reflection occurs at the reflective polarizing element RP. The light after the first reflection passes through the first quarter-wave plate QWP1, the second lens E2, and the third lens E3, and reaches the partially reflective element BS located on the near-screen side surface of the third lens E3, where a second reflection occurs at the partially reflective element BS. The light after the second reflection sequentially passes through the third lens E3, the second lens E2, the first quarter-wave plate QWP1, the reflective polarizing element RP, the first lens E1, and reaches the aperture stop, and is finally projected into the eye of the user. For example, the light rays from this optical system, after two reflections, are finally projected into the eye of the user. A protective glass (not shown) may also be disposed between the imaging surface IMG and the polarizer LP.

Table 3 shows a basic parameter table of the optical system of Embodiment 2, wherein the units for radius of curvature and thickness/distance are all millimeters (mm). Image light from the imaging surface IMG passes through each element in the order from serial No. 23 to serial No. 1 and is finally projected into the human eye.

TABLE 3

| | | | | | Material | | | |
|---|---|---|---|---|---|---|---|---|
| | | Surface | Radius of | Thickness/ | Refractive | Abbe | Refraction/ | Cone |
| No. | Element | Type | curvature | Distance | Index | Number | Reflection | coefficient |
| | | spherical | Infinity | −100000.0000 | | | Refraction | |
| 1 | Aperture Stop | spherical | Infinity | 20.0000 | | | Refraction | |
| 2 | First Lens | spherical | 18.1762 | 7.0100 | 1.616 | 60.61 | Refraction | |
| 3 | | spherical | 201.0316 | 1.5477 | | | Refraction | |
| 4 | Reflective polarizing | spherical | Infinity | 0.1100 | 1.502 | 57.00 | Refraction | |
| | element | | | | | | | |
| 5 | First quarter-wave | spherical | Infinity | 0.1100 | 1.502 | 57.00 | Refraction | |
| | plate | | | | | | | |
| 6 | Second lens | spherical | Infinity | 5.5000 | 1.500 | 57.28 | Refraction | |
| 7 | | spherical | −39.8231 | 0.2485 | | | Refraction | |
| 8 | Third lens | aspherical | −50.5584 | 7.7232 | 1.746 | 28.24 | Refraction | 0.0000 |
| 9 | Partially reflective | aspherical | 800.0000 | −7.7232 | 1.746 | 28.24 | Reflection | 0.0000 |
| | element | | | | | | | |
| 10 | | aspherical | −50.5584 | −0.2485 | | | Refraction | 0.0000 |
| 11 | | spherical | −39.8231 | −5.5000 | 1.500 | 57.28 | Refraction | |
| 12 | | spherical | Infinity | −0.1100 | 1.502 | 57.00 | Refraction | |
| 13 | Reflective polarizing | spherical | Infinity | 0.1100 | 1.502 | 57.00 | Reflection | |
| | element | | | | | | | |
| 14 | Second lens | spherical | Infinity | 5.5000 | 1.500 | 57.28 | Refraction | |
| 15 | | spherical | −39.8231 | 0.2485 | | | Refraction | |
| 16 | Third lens | aspherical | −50.5584 | 7.7232 | 1.746 | 28.24 | Refraction | 0.0000 |
| 17 | | aspherical | 800.0000 | 1.1905 | | | Refraction | 0.0000 |
| 18 | Fourth lens | aspherical | −21.2368 | 1.3000 | 1.747 | 27.77 | Refraction | 0.0000 |
| 19 | Second quarter-wave | spherical | Infinity | 0.1000 | 1.502 | 57.00 | Refraction | |
| | plate | | | | | | | |
| 20 | Polarizer | spherical | Infinity | 0.1500 | 1.502 | 57.00 | Refraction | |
| 21 | | spherical | Infinity | 1.2000 | | | Refraction | |
| 22 | Protective glass | spherical | Infinity | 0.7100 | 1.519 | 64.17 | Refraction | |
| 23 | | spherical | Infinity | 0.1000 | | | Refraction | |
| | Imaging surface | spherical | Infinity | 0.0000 | | | Refraction | |

In this embodiment, the near-human eye side surface S5 and the near-screen side surface S6 of the third lens E3, and the near-human eye side surface S7 of the fourth lens E4 are all aspherical surfaces. Table 4 provides the higher-order coefficients A4, A6, A8, A10, A12, A14, A16, A18, and A20 for the aspherical surfaces S5-S7 used in Embodiment 2.

TABLE 4

| Surface | | | | | |
|---|---|---|---|---|---|
| Number | A4 | A6 | A8 | A10 | A12 |
| S5 | −1.7566E+00 | −9.1856E−01 | −6.6580E−01 | −3.1489E−01 | −1.1832E−01 |
| S6 | 7.7626E−01 | 1.5793E−01 | 1.1307E−02 | 2.3290E−02 | 1.3885E−02 |
| S7 | 1.0218E−01 | −2.8597E−02 | −3.6943E−03 | −2.9453E−03 | −9.3725E−04 |

| Surface | | | | |
|---|---|---|---|---|
| Number | A14 | A16 | A18 | A20 |
| S5 | −3.0614E−02 | −4.3324E−03 | 0.0000E+00 | 0.0000E+00 |
| S6 | 3.6322E−03 | 2.4337E−04 | 0.0000E+00 | 0.0000E+00 |
| S7 | 0.0000E+00 | 0.0000E+00 | 0.0000E+00 | 0.0000E+00 |

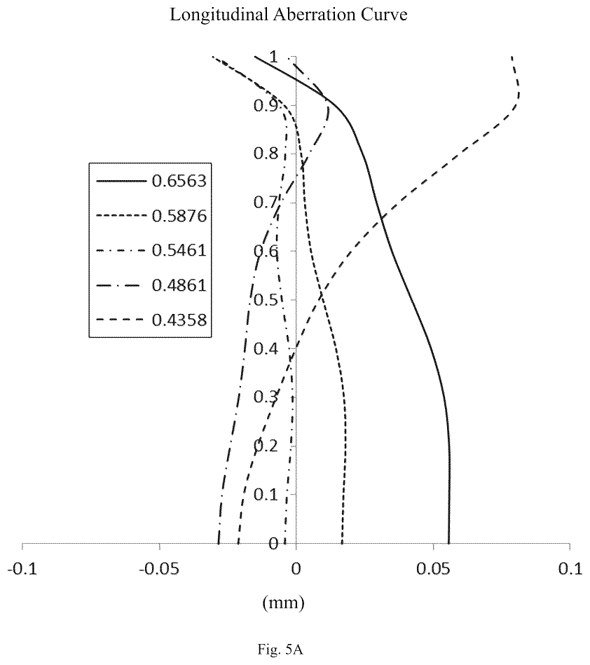

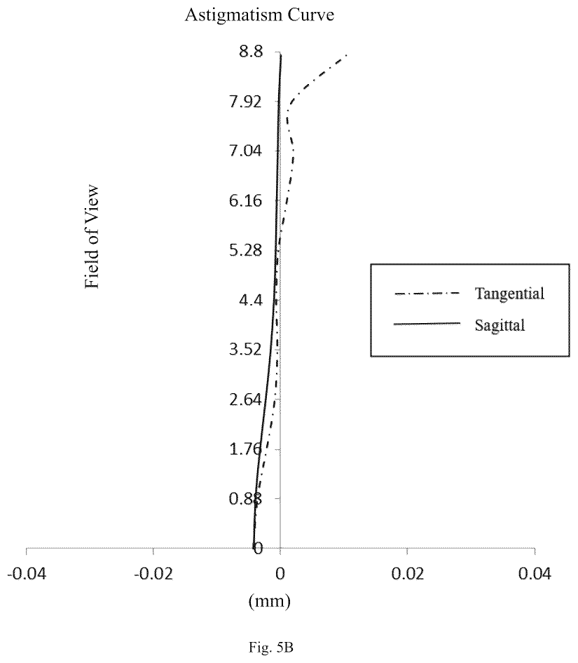

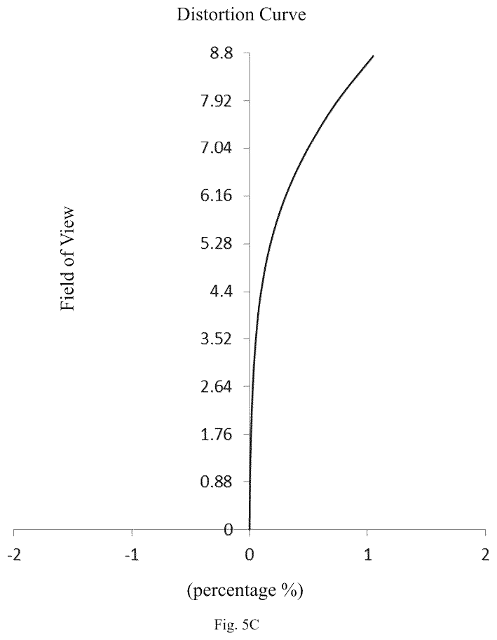

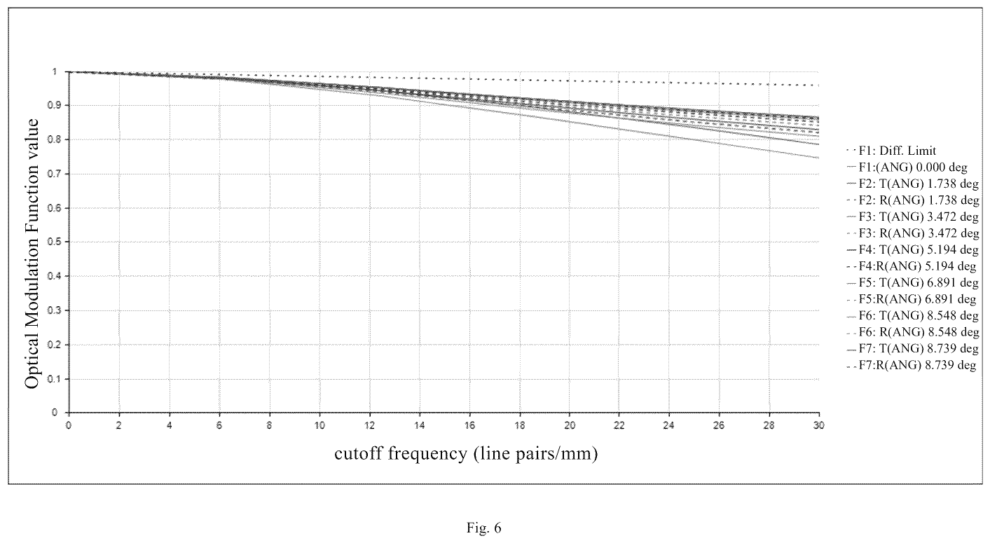

FIG. 5A shows a longitudinal aberration curve of the optical system of Embodiment 2, which represents the deviation of the converging point after light rays of different wavelengths pass through the optical system. FIG. 5B shows an astigmatism curve of the optical system of Embodiment 2, which represents the curvature of a tangential plane and the curvature of a sagittal plane corresponding to different field angles. FIG. 5C shows a distortion curve of the optical system of Embodiment 2, which represents the magnitude of distortion corresponding to different field angles. FIG. 6 shows a Modulation Transfer Function curve of the optical system of Embodiment 2. As can be seen from FIGS. 5A to 5C and FIG. 6, the optical system provided in Embodiment 2 can achieve good imaging quality.

### Embodiment 3

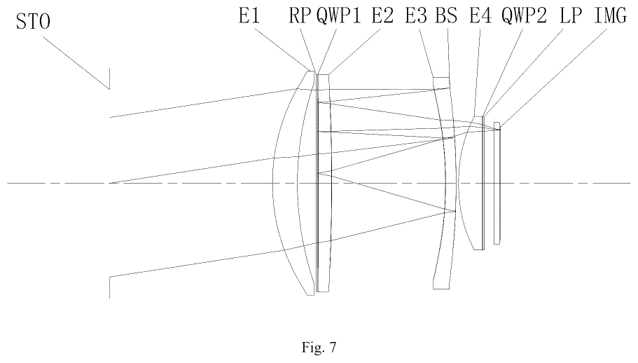

Hereinafter, an optical system according to Embodiment 3 of the present application will be described with reference to FIGS. 7, 8A to 8C, and 9.

As shown in FIG. 7, the optical system may comprise, arranged sequentially along an optical axis from a first side to a second side, a first lens E1, a reflective polarizing element RP, a first quarter-wave plate QWP1, a second lens E2, a third lens E3, a partially reflective element BS, a fourth lens E4, a second quarter-wave plate QWP2, and a polarizer LP. An aperture stop STO may be arranged between the first side and the first lens E1. In this embodiment, the first side refers to the human eye side, and the second side refers to the display screen side. The first side surface of each element is referred to as the near-human eye side surface, and the second side surface is referred to as the near-screen side surface.

The first lens E1 has positive refractive power, and its near-human eye side surface S1 is a convex surface, and its near-screen side surface S2 is a concave surface. The second lens E2 has positive refractive power, and its near-human eye side surface S3 is a plane, and its near-screen side surface S4 is a convex surface. The third lens E3 has negative refractive power, and its near-human eye side surface S5 is a concave surface, and its near-screen side surface S6 is a convex surface. The fourth lens E4 has positive refractive power, and its near-human eye side surface S7 is a convex surface, and its near-screen side surface S8 is a plane. The reflective polarizing element RP and the first quarter-wave plate QWP1 are attached to the near-human eye side surface S3 of the second lens E2. The partially reflective element BS is attached to the near-screen side surface S6 of the third lens E3. The second quarter-wave plate QWP2 and the polarizer LP are attached to the near-screen side surface S8 of the fourth lens E4.

In this example, an imaging surface IMG may be provided on the second side of the optical system, and the imaging surface IMG may, for example, be provided with a display screen. Image light from the imaging surface IMG sequentially passes through the polarizer LP, the second quarter-wave plate QWP2, the fourth lens E4, the third lens E3, the second lens E2, and the first quarter-wave plate QWP1, and reaches the reflective polarizing element RP, where a first reflection occurs at the reflective polarizing element RP. The light after the first reflection passes through the first quarter-wave plate QWP1, the second lens E2, and the third lens E3, and reaches the partially reflective element BS located on the near-screen side surface of the third lens E3, where a second reflection occurs at the partially reflective element BS. The light after the second reflection sequentially passes through the third lens E3, the second lens E2, the first quarter-wave plate QWP1, the reflective polarizing element RP, the first lens E1, and reaches the aperture stop, and is finally projected into the eye of the user. For example, the light rays from this optical system, after two reflections, are finally projected into the eye of the user. A protective glass (not shown) may also be disposed between the imaging surface IMG and the polarizer LP.

Table 5 shows a basic parameter table of the optical system of Embodiment 3, wherein the units for radius of curvature and thickness/distance are all millimeters (mm). Image light from the imaging surface IMG passes through each element in the order from serial No. 23 to serial No. 1 and is finally projected into the human eye.

TABLE 5

| | | | | | Material | | | |
|---|---|---|---|---|---|---|---|---|
| | | Surface | Radius of | Thickness/ | Refractive | Abbe | Refraction/ | Cone |
| No. | Element | Type | curvature | Distance | Index | Number | Reflection | coefficient |
| | | spherical | Infinity | −100000.0000 | | | Refraction | |
| 1 | Aperture Stop | spherical | Infinity | 20.0000 | | | Refraction | |
| 2 | First Lens | spherical | 23.7008 | 3.0649 | 1.489 | 70.42 | Refraction | |
| 3 | | spherical | 37.9560 | 2.3373 | | | Refraction | |
| 4 | Reflective polarizing | spherical | Infinity | 0.1100 | 1.502 | 57.00 | Refraction | |
| | element | | | | | | | |
| 5 | First quarter-wave | spherical | Infinity | 0.1100 | 1.502 | 57.00 | Refraction | |
| | plate | | | | | | | |
| 6 | Second lens | spherical | Infinity | 1.6486 | 1.489 | 70.42 | Refraction | |
| 7 | | spherical | −244.5710 | 13.9775 | | | Refraction | |
| 8 | Third lens | aspherical | −49.5935 | 1.3000 | 1.546 | 56.14 | Refraction | 0.0000 |
| 9 | Partially reflective | aspherical | −89.0878 | −1.3000 | 1.546 | 56.14 | Reflection | 0.0000 |
| | element | | | | | | | |
| 10 | | aspherical | −49.5935 | −13.9775 | | | Refraction | 0.0000 |
| 11 | | spherical | −244.5710 | −1.6486 | 1.489 | 70.42 | Refraction | |
| 12 | | spherical | Infinity | −0.1100 | 1.502 | 57.00 | Refraction | |
| 13 | Reflective polarizing | spherical | Infinity | 0.1100 | 1.502 | 57.00 | Reflection | |
| | element | | | | | | | |
| 14 | Second lens | spherical | Infinity | 1.6486 | 1.489 | 70.42 | Refraction | |
| 15 | | spherical | −244.5710 | 13.9775 | | | Refraction | |
| 16 | Third lens | aspherical | −49.5935 | 1.3000 | 1.546 | 56.14 | Refraction | 0.0000 |
| 17 | | aspherical | −89.0878 | 0.2998 | | | Refraction | 0.0000 |
| 18 | Fourth lens | aspherical | 20.7261 | 2.8919 | 1.525 | 59.51 | Refraction | 0.0000 |
| 19 | Second quarter-wave | spherical | Infinity | 0.1000 | 1.502 | 57.00 | Refraction | |
| | plate | | | | | | | |
| 20 | Polarizer | spherical | Infinity | 0.1500 | 1.502 | 57.00 | Refraction | |
| 21 | | spherical | Infinity | 1.2000 | | | Refraction | |
| 22 | Protective glass | spherical | Infinity | 0.7100 | 1.519 | 64.17 | Refraction | |
| 23 | | spherical | Infinity | 0.1000 | | | Refraction | |
| | Imaging surface | spherical | Infinity | 0.0000 | | | Refraction | |

In this embodiment, the near-human eye side surface S5 and the near-screen side surface S6 of the third lens E3, and the near-human eye side surface S7 of the fourth lens E4 are all aspherical surfaces. Table 6 provides the higher-order coefficients A4, A6, A8, A10, A12, A14, A16, A18, and A20 for the aspherical surfaces S5-S7 used in Embodiment 3.

TABLE 6

| Surface | | | | | |
|---|---|---|---|---|---|
| Number | A4 | A6 | A8 | A10 | A12 |
| S5 | −3.2408E−01 | −2.2957E−01 | −3.3271E−01 | −2.0137E−01 | −1.1801E−01 |
| S6 | 5.2280E−02 | 4.6291E−03 | −4.7358E−02 | −2.6200E−02 | −1.7878E−02 |
| S7 | 1.7461E−01 | −2.2494E−03 | −1.6176E−03 | 1.6677E−04 | −3.0210E−04 |

| Surface | | | | |
|---|---|---|---|---|
| Number | A14 | A16 | A18 | A20 |
| S5 | −5.3238E−02 | −9.1168E−03 | 0.0000E+00 | 0.0000E+00 |
| S6 | −1.0288E−02 | −1.8757E−03 | 0.0000E+00 | 0.0000E+00 |
| S7 | 0.0000E+00 | 0.0000E+00 | 0.0000E+00 | 0.0000E+00 |

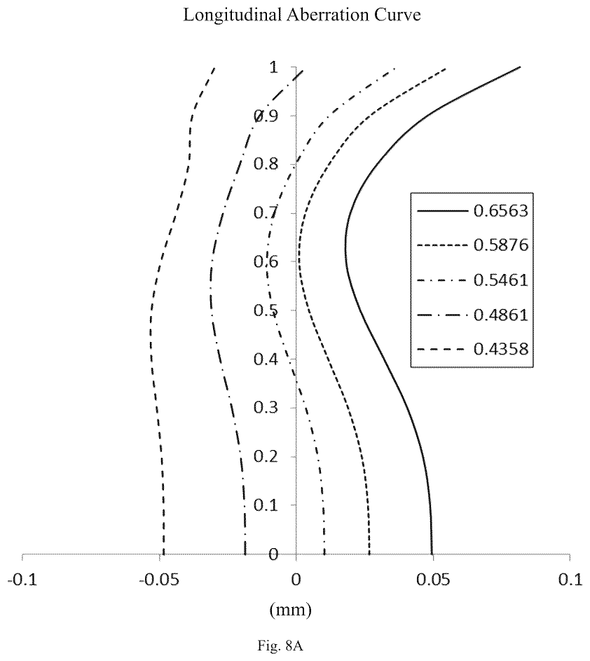

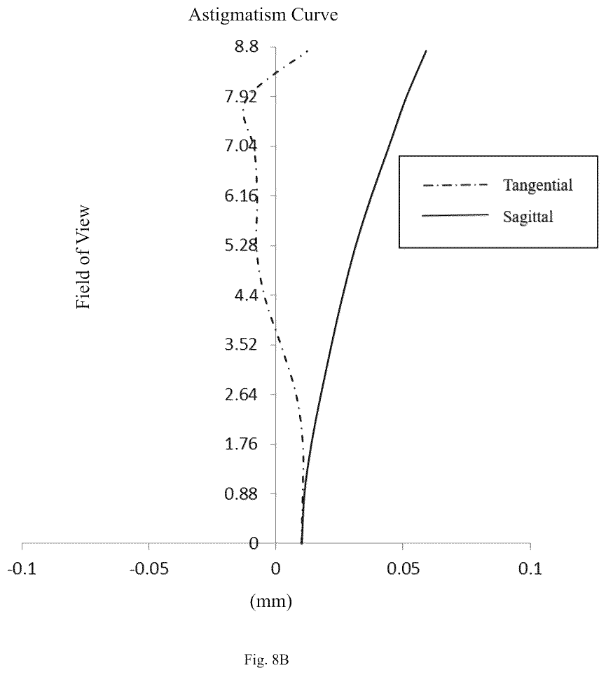

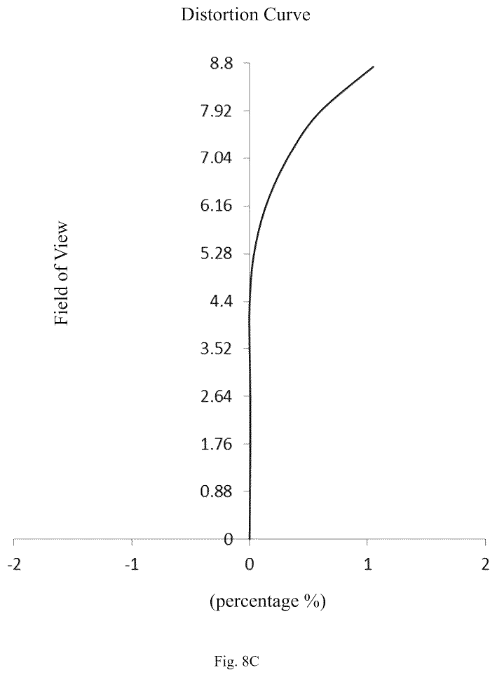

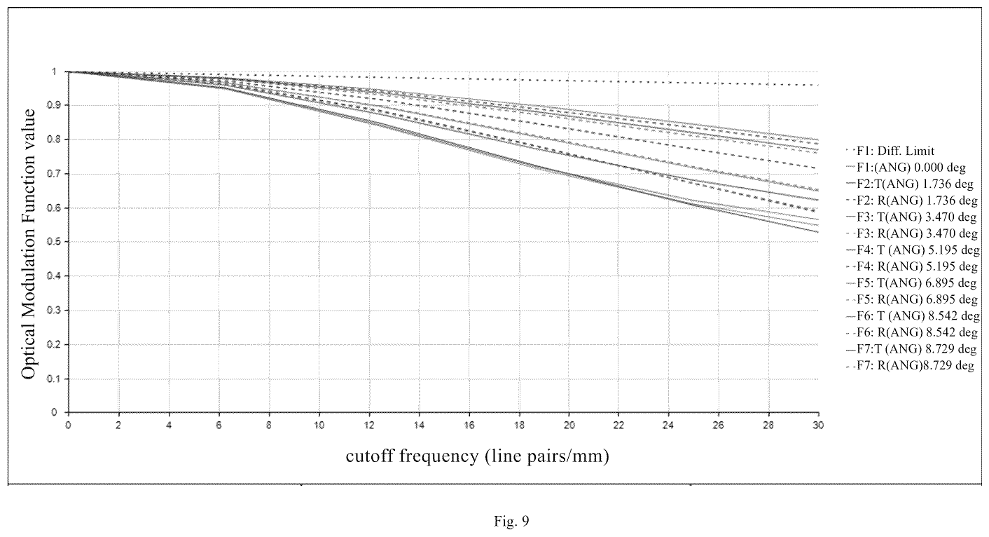

FIG. 8A shows a longitudinal aberration curve of the optical system of Embodiment 3, which represents the deviation of the converging point after light rays of different wavelengths pass through the optical system. FIG. 8B shows an astigmatism curve of the optical system of Embodiment 3, which represents the curvature of a tangential plane and the curvature of a sagittal plane corresponding to different field angles. FIG. 8C shows a distortion curve of the optical system of Embodiment 3, which represents the magnitude of distortion corresponding to different field angles. FIG. 9 shows a Modulation Transfer Function curve of the optical system of Embodiment 3. As can be seen from FIGS. 8A to 8C and FIG. 9, the optical system provided in Embodiment 3 can achieve good imaging quality.

### Embodiment 4

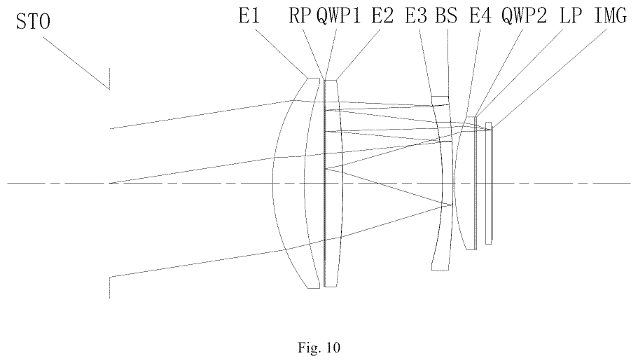

Hereinafter, an optical system according to Embodiment 4 of the present application will be described with reference to FIGS. 10, 11A to 11C, and 12.

As shown in FIG. 10, the optical system may comprise, arranged sequentially along an optical axis from a first side to a second side, a first lens E1, a reflective polarizing element RP, a first quarter-wave plate QWP1, a second lens E2, a third lens E3, a partially reflective element BS, a fourth lens E4, a second quarter-wave plate QWP2, and a polarizer LP. An aperture stop STO may be arranged between the first side and the first lens E1. In this embodiment, the first side refers to the human eye side, and the second side refers to the display screen side. The first side surface of each element is referred to as the near-human eye side surface, and the second side surface is referred to as the near-screen side surface.

The first lens E1 has positive refractive power, and its near-human eye side surface S1 is a convex surface, and its near-screen side surface S2 is a concave surface. The second lens E2 has positive refractive power, and its near-human eye side surface S3 is a plane, and its near-screen side surface S4 is a convex surface. The third lens E3 has negative refractive power, and its near-human eye side surface S5 is a concave surface, and its near-screen side surface S6 is a convex surface. The fourth lens E4 has positive refractive power, and its near-human eye side surface S7 is a convex surface, and its near-screen side surface S8 is a plane. The reflective polarizing element RP and the first quarter-wave plate QWP1 are attached to the near-human eye side surface S3 of the second lens E2. The partially reflective element BS is attached to the near-screen side surface S6 of the third lens E3. The second quarter-wave plate QWP2 and the polarizer LP are attached to the near-screen side surface S8 of the fourth lens E4.

In this example, an imaging surface IMG may be provided on the second side of the optical system, and the imaging surface IMG may, for example, be provided with a display screen. Image light from the imaging surface IMG sequentially passes through the polarizer LP, the second quarter-wave plate QWP2, the fourth lens E4, the third lens E3, the second lens E2, and the first quarter-wave plate QWP1, and reaches the reflective polarizing element RP, where a first reflection occurs at the reflective polarizing element RP. The light after the first reflection passes through the first quarter-wave plate QWP1, the second lens E2, and the third lens E3, and reaches the partially reflective element BS located on the near-screen side surface of the third lens E3, where a second reflection occurs at the partially reflective element BS. The light after the second reflection sequentially passes through the third lens E3, the second lens E2, the first quarter-wave plate QWP1, the reflective polarizing element RP, the first lens E1, and reaches the aperture stop, and is finally projected into the eye of the user. For example, the light rays from this optical system, after two reflections, are finally projected into the eye of the user. A protective glass (not shown) may also be disposed between the imaging surface IMG and the polarizer LP.

Table 7 shows a basic parameter table of the optical system of Embodiment 4, wherein the units for radius of curvature and thickness/distance are all millimeters (mm). Image light from the imaging surface IMG passes through each element in the order from serial No. 23 to serial No. 1 and is finally projected into the human eye.

TABLE 7

| | | | | | Material | | | |
|---|---|---|---|---|---|---|---|---|
| | | Surface | Radius of | Thickness/ | Refractive | Abbe | Refraction/ | Cone |
| No. | Element | Type | curvature | Distance | Index | Number | Reflection | coefficient |
| | | spherical | Infinity | −100000.0000 | | | Refraction | |
| 1 | Aperture Stop | spherical | Infinity | 20.0000 | | | Refraction | |
| 2 | First Lens | spherical | 21.2211 | 3.9012 | 1.489 | 70.24 | Refraction | |
| 3 | | spherical | 40.6567 | 2.3960 | | | Refraction | |
| 4 | Reflective polarizing | spherical | Infinity | 0.1100 | 1.502 | 57.00 | Refraction | |
| | element | | | | | | | |
| 5 | First quarter-wave plate | spherical | Infinity | 0.1100 | 1.502 | 57.00 | Refraction | |
| 6 | Second lens | spherical | Infinity | 2.1388 | 1.489 | 70.24 | Refraction | |
| 7 | | aspherical | −93.6179 | 12.2208 | | | Refraction | −2.6949 |
| 8 | Third lens | aspherical | −40.5015 | 1.3000 | 1.607 | 38.01 | Refraction | 0.0000 |
| 9 | Partially reflective element | aspherical | −98.6244 | −1.3000 | 1.607 | 38.01 | Reflection | 0.0000 |
| 10 | | aspherical | −40.5015 | −12.2208 | | | Refraction | 0.0000 |
| 11 | | aspherical | −93.6179 | −2.1388 | 1.489 | 70.24 | Refraction | −2.6949 |
| 12 | | spherical | Infinity | −0.1100 | 1.502 | 57.00 | Refraction | |
| 13 | Reflective polarizing | spherical | Infinity | 0.1100 | 1.502 | 57.00 | Reflection | |
| | element | | | | | | | |
| 14 | Second lens | spherical | Infinity | 2.1388 | 1.489 | 70.24 | Refraction | |
| 15 | | aspherical | −93.6179 | 12.2208 | | | Refraction | −2.6949 |
| 16 | Third lens | aspherical | −40.5015 | 1.3000 | 1.607 | 38.01 | Refraction | 0.0000 |
| 17 | | aspherical | −98.6244 | 0.1999 | | | Refraction | 0.0000 |
| 18 | Fourth lens | aspherical | 28.0282 | 2.4570 | 1.855 | 23.62 | Refraction | 0.0000 |
| 19 | Second quarter-wave plate | spherical | Infinity | 0.1000 | 1.502 | 57.00 | Refraction | |
| 20 | Polarizer | spherical | Infinity | 0.1500 | 1.502 | 57.00 | Refraction | |
| 21 | | spherical | Infinity | 1.1063 | | | Refraction | |
| 22 | Protective glass | spherical | Infinity | 0.7100 | 1.519 | 64.17 | Refraction | |
| 23 | | spherical | Infinity | 0.1000 | | | Refraction | |
| | Imaging surface | spherical | Infinity | 0.0000 | | | Refraction | |

In this embodiment, the near-screen side surface S4 of the second lens E2, the near-human eye side surface S5 and the near-screen side surface S6 of the third lens E3, and the near-human eye side surface S7 of the fourth lens E4 are all aspherical surfaces. Table 8 provides the higher-order coefficients A4, A6, A8, A10, A12, A14, A16, A18, and A20 for the aspherical surfaces S4-S7 used in Embodiment 4.

TABLE 8

| Surface | | | | | |
|---|---|---|---|---|---|
| Number | A4 | A6 | A8 | A10 | A12 |
| S4 | 4.3326E−02 | −3.0161E−03 | −4.3411E−05 | −1.6166E−05 | 3.7953E−06 |
| S5 | −3.8479E−01 | 1.1258E−01 | 6.1473E−02 | −5.1302E−03 | −2.5956E−02 |
| S6 | −1.7396E−02 | 2.4428E−04 | −1.4953E−02 | −1.7120E−02 | −1.2611E−02 |
| S7 | 1.3806E−01 | 6.7857E−04 | 7.1623E−04 | −1.4453E−04 | 2.9049E−05 |

| Surface | | | | |
|---|---|---|---|---|
| Number | A14 | A16 | A18 | A20 |
| S4 | 0.0000E+00 | 0.0000E+00 | 0.0000E+00 | 0.0000E+00 |
| S5 | −1.5649E−02 | −3.6736E−03 | 0.0000E+00 | 0.0000E+00 |
| S6 | −5.6990E−03 | −1.2368E−03 | 0.0000E+00 | 0.0000E+00 |
| S7 | 0.0000E+00 | 0.0000E+00 | 0.0000E+00 | 0.0000E+00 |

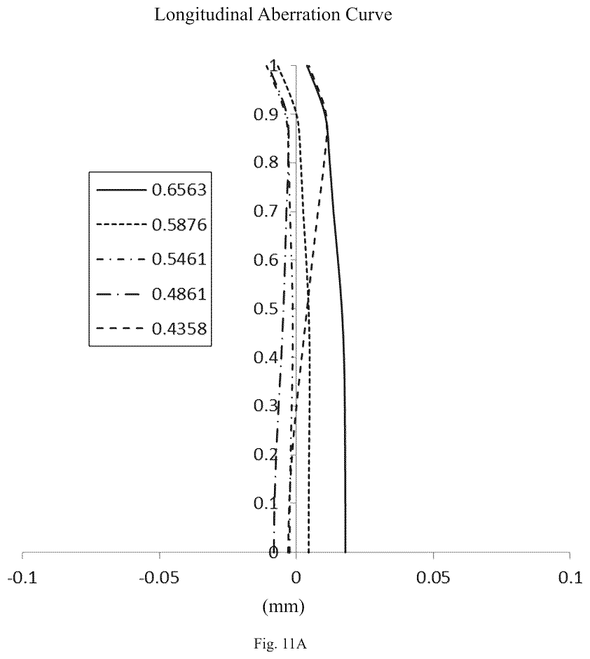

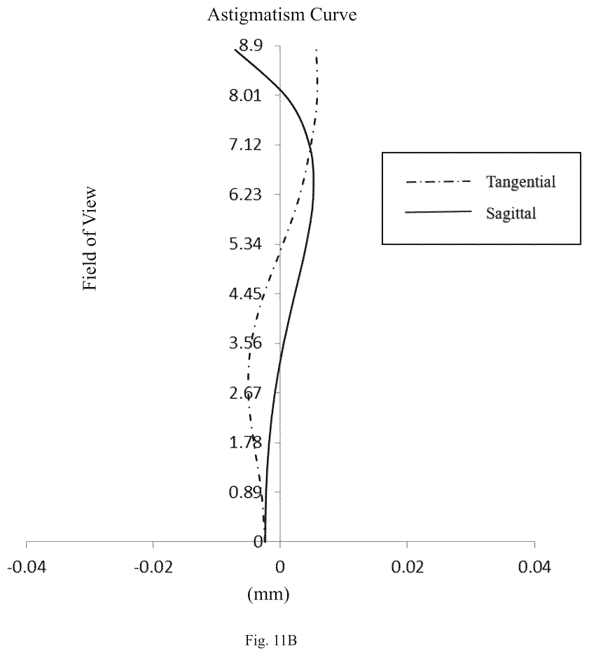

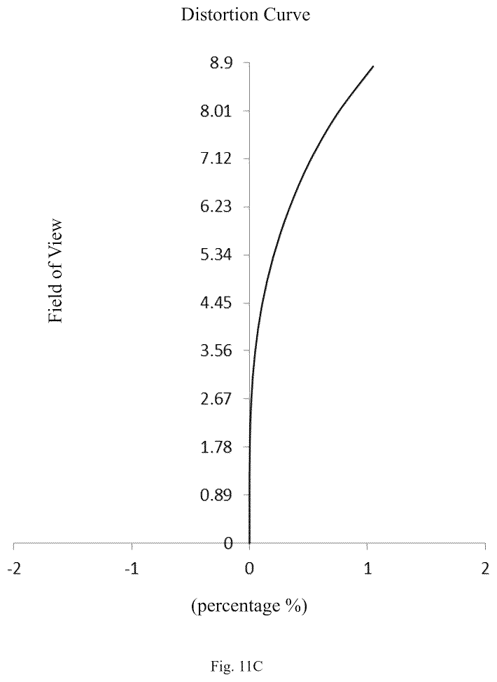

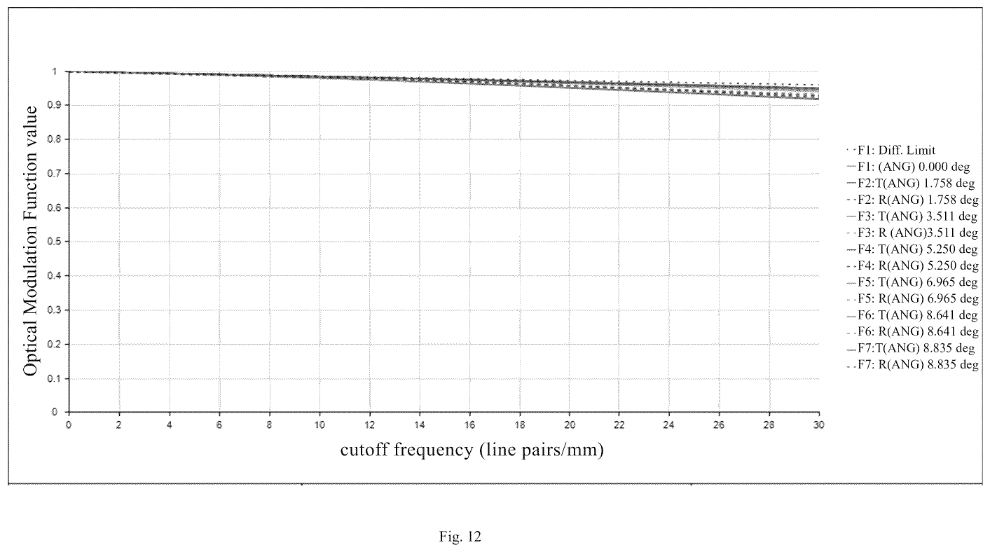

FIG. 11A shows a longitudinal aberration curve of the optical system of Embodiment 4, which represents the deviation of the converging point after light rays of different wavelengths pass through the optical system. FIG. 11B shows an astigmatism curve of the optical system of Embodiment 4, which represents the curvature of a tangential plane and the curvature of a sagittal plane corresponding to different field angles. FIG. 11C shows a distortion curve of the optical system of Embodiment 4, which represents the magnitude of distortion corresponding to different field angles. FIG. 12 shows a Modulation Transfer Function curve of the optical system of Embodiment 4. As can be seen from FIGS. 11A to 11C and FIG. 12, the optical system provided in Embodiment 4 can achieve good imaging quality.

### Embodiment 5

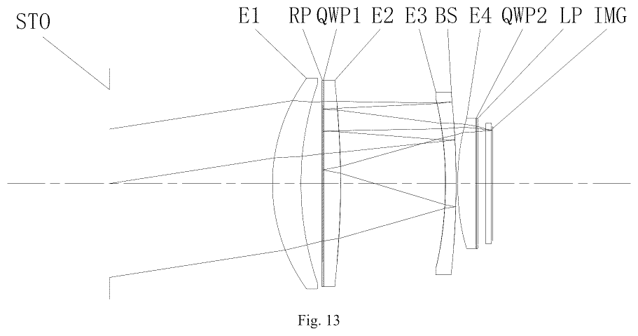

Hereinafter, an optical system according to Embodiment 5 of the present application will be described with reference to FIGS. 13, 14A to 14C, and 15.

As shown in FIG. 13, the optical system may comprise, arranged sequentially along an optical axis from a first side to a second side, a first lens E1, a reflective polarizing element RP, a first quarter-wave plate QWP1, a second lens E2, a third lens E3, a partially reflective element BS, a fourth lens E4, a second quarter-wave plate QWP2, and a polarizer LP. An aperture stop STO may be arranged between the first side and the first lens E1. In this embodiment, the first side refers to the human eye side, and the second side refers to the display screen side. The first side surface of each element is referred to as the near-human eye side surface, and the second side surface is referred to as the near-screen side surface.

The first lens E1 has positive refractive power, and its near-human eye side surface S1 is a convex surface, and its near-screen side surface S2 is a concave surface. The second lens E2 has positive refractive power, and its near-human eye side surface S3 is a plane, and its near-screen side surface S4 is a convex surface. The third lens E3 has negative refractive power, and its near-human eye side surface S5 is a concave surface, and its near-screen side surface S6 is a convex surface. The fourth lens E4 has positive refractive power, and its near-human eye side surface S7 is a convex surface, and its near-screen side surface S8 is a plane. The reflective polarizing element RP and the first quarter-wave plate QWP1 are attached to the near-human eye side surface S3 of the second lens E2. The partially reflective element BS is attached to the near-screen side surface S6 of the third lens E3. The second quarter-wave plate QWP2 and the polarizer LP are attached to the near-screen side surface S8 of the fourth lens E4.

In this example, an imaging surface IMG may be provided on the second side of the optical system, and the imaging surface IMG may, for example, be provided with a display screen. Image light from the imaging surface IMG sequentially passes through the polarizer LP, the second quarter-wave plate QWP2, the fourth lens E4, the third lens E3, the second lens E2, and the first quarter-wave plate QWP1, and reaches the reflective polarizing element RP, where a first reflection occurs at the reflective polarizing element RP. The light after the first reflection passes through the first quarter-wave plate QWP1, the second lens E2, and the third lens E3, and reaches the partially reflective element BS located on the near-screen side surface of the third lens E3, where a second reflection occurs at the partially reflective element BS. The light after the second reflection sequentially passes through the third lens E3, the second lens E2, the first quarter-wave plate QWP1, the reflective polarizing element RP, the first lens E1, and reaches the aperture stop, and is finally projected into the eye of the user. For example, the light rays from this optical system, after two reflections, are finally projected into the eye of the user A protective glass (not shown) may also be disposed between the imaging surface IMG and the polarizer LP.

Table 9 shows a basic parameter table of the optical system of Embodiment 5, wherein the units for radius of curvature and thickness/distance are all millimeters (mm). Image light from the imaging surface IMG passes through each element in the order from serial No. 23 to serial No. 1 and is finally projected into the human eye.

TABLE 9

| | | | | | Material | | | |
|---|---|---|---|---|---|---|---|---|
| | | Surface | Radius of | Thickness/ | Refractive | Abbe | Refraction/ | Cone |
| No. | Element | Type | curvature | Distance | Index | Number | Reflection | coefficient |
| | | spherical | Infinity | −100000.0000 | | | Refraction | |
| 1 | Aperture Stop | spherical | Infinity | 20.0000 | | | Refraction | |
| 2 | First Lens | spherical | 21.9498 | 3.5026 | 1.489 | 70.24 | Refraction | |
| 3 | | spherical | 37.7304 | 2.5760 | | | Refraction | |
| 4 | Reflective polarizing | spherical | Infinity | 0.1100 | 1.502 | 57.00 | Refraction | |
| | element | | | | | | | |
| 5 | First quarter-wave plate | spherical | Infinity | 0.1100 | 1.502 | 57.00 | Refraction | |
| 6 | Second lens | spherical | Infinity | 2.0728 | 1.489 | 70.24 | Refraction | |
| 7 | | aspherical | −97.8292 | 12.8734 | | | Refraction | −8.7177 |
| 8 | Third lens | aspherical | −48.2695 | 1.3000 | 1.628 | 35.94 | Refraction | 0.0000 |
| 9 | Partially reflective | aspherical | −102.7114 | −1.3000 | 1.628 | 35.94 | Reflection | 0.0000 |
| | element | | | | | | | |
| 10 | | aspherical | −48.2695 | −12.8734 | | | Refraction | 0.0000 |
| 11 | | aspherical | −97.8292 | −2.0728 | 1.489 | 70.24 | Refraction | −8.7177 |
| 12 | | spherical | Infinity | −0.1100 | 1.502 | 57.00 | Refraction | |
| 13 | Reflective polarizing | spherical | Infinity | 0.1100 | 1.502 | 57.00 | Reflection | |
| | element | | | | | | | |
| 14 | Second lens | spherical | Infinity | 2.0728 | 1.489 | 70.24 | Refraction | |
| 15 | | aspherical | −97.8292 | 12.8734 | | | Refraction | −8.7177 |
| 16 | Third lens | aspherical | −48.2695 | 1.3000 | 1.628 | 35.94 | Refraction | 0.0000 |
| 17 | | aspherical | −102.7114 | 0.1999 | | | Refraction | 0.0000 |
| 18 | Fourth lens | aspherical | 33.2068 | 2.1954 | 1.855 | 23.62 | Refraction | 0.0000 |
| 19 | Second quarter-wave | spherical | Infinity | 0.1000 | 1.502 | 57.00 | Refraction | |
| | plate | | | | | | | |
| 20 | Polarizer | spherical | Infinity | 0.1500 | 1.502 | 57.00 | Refraction | |
| 21 | | spherical | Infinity | 1.0000 | | | Refraction | |
| 22 | Protective glass | spherical | Infinity | 0.7100 | 1.519 | 64.17 | Refraction | |
| 23 | | spherical | Infinity | 0.1000 | | | Refraction | |
| | Imaging surface | spherical | Infinity | 0.0000 | | | Refraction | |

In this embodiment, the near-screen side surface S4 of the second lens E2, the near-human eye side surface S5 and the near-screen side surface S6 of the third lens E3, and the near-human eye side surface S7 of the fourth lens E4 are all aspherical surfaces. Table 10 provides the higher-order coefficients A4, A6, A8, A10, A12, A14, A16, A18, and A20 for the aspherical surfaces S4-S7 used in Embodiment 5.

TABLE 10

| Surface | | | | | |
|---|---|---|---|---|---|
| Number | A4 | A6 | A8 | A10 | A12 |
| S4 | 4.3986E−02 | −2.0543E−03 | −2.0872E−05 | −9.4960E−06 | 7.6199E−07 |
| S5 | −1.9456E−01 | 1.6301E−02 | 2.0676E−02 | −1.3665E−02 | −1.6130E−02 |
| S6 | 1.9752E−02 | −4.9490E−03 | −7.2719E−03 | −1.1055E−02 | −6.8125E−03 |
| S7 | 8.6077E−02 | 8.7608E−04 | −1.6652E−04 | −1.7153E−04 | 1.1682E−04 |

| Surface | | | | |
|---|---|---|---|---|
| Number | A14 | A16 | A18 | A20 |
| S4 | 0.0000E+00 | 0.0000E+00 | 0.0000E+00 | 0.0000E+00 |
| S5 | −1.2575E−02 | −1.2809E−03 | 0.0000E+00 | 0.0000E+00 |
| S6 | −4.4695E−03 | −5.0325E−04 | 0.0000E+00 | 0.0000E+00 |
| S7 | 0.0000E+00 | 0.0000E+00 | 0.0000E+00 | 0.0000E+00 |

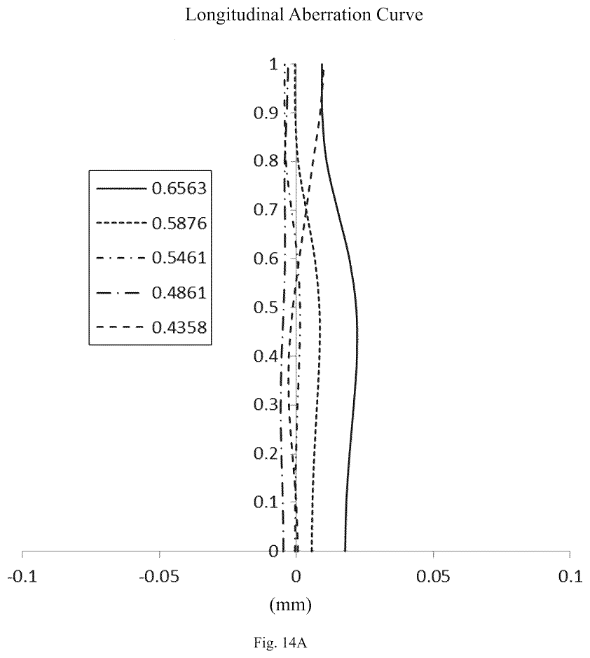

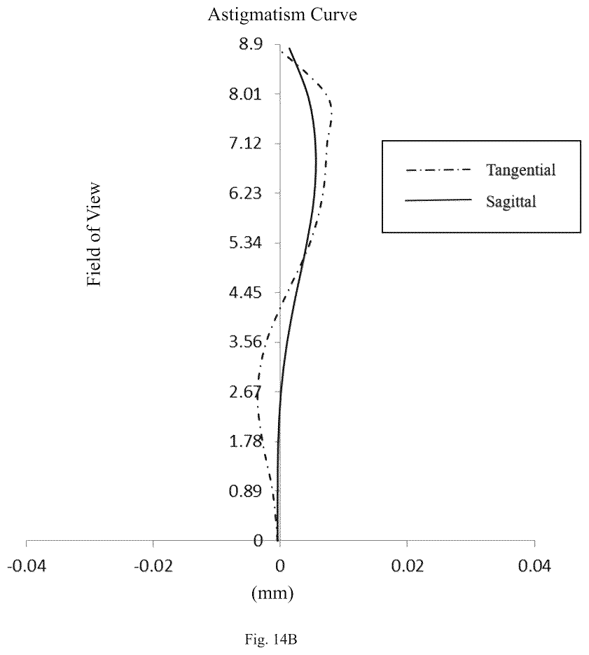

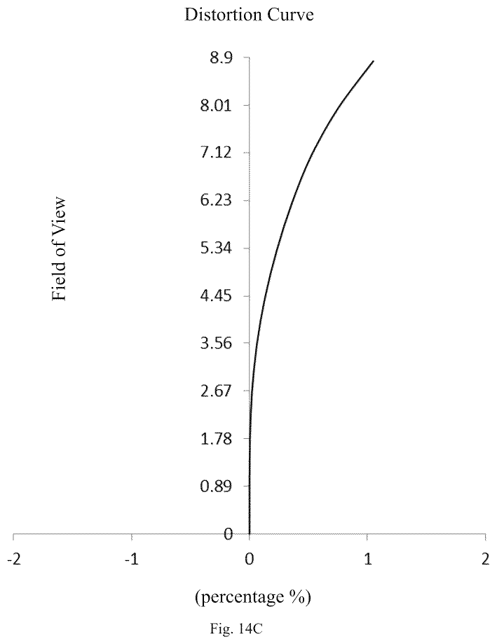

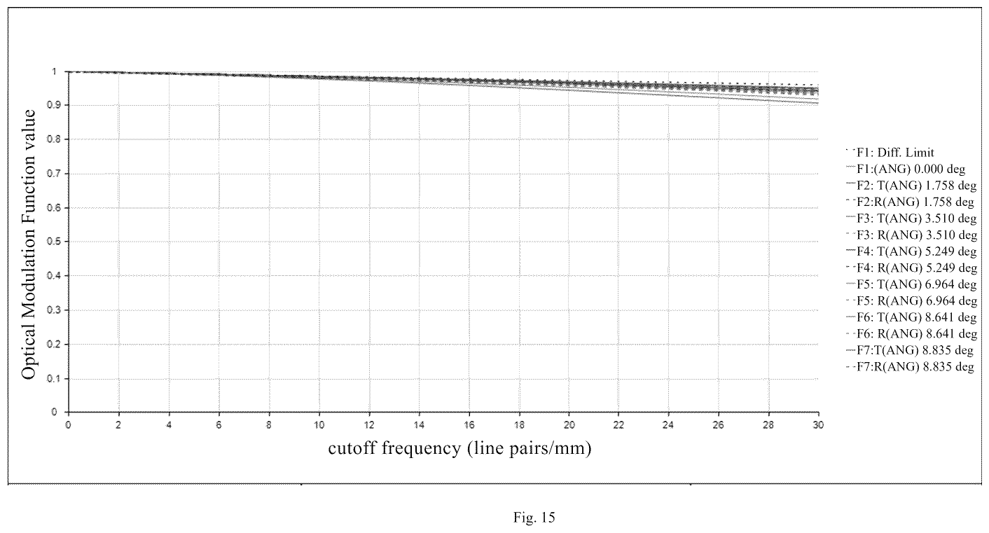

FIG. 14A shows a longitudinal aberration curve of the optical system of Embodiment 5, which represents the deviation of the converging point after light rays of different wavelengths pass through the optical system. FIG. 14B shows an astigmatism curve of the optical system of Embodiment 5, which represents the curvature of a tangential plane and the curvature of a sagittal plane corresponding to different field angles. FIG. 14C shows a distortion curve of the optical system of Embodiment 5, which represents the magnitude of distortion corresponding to different field angles. FIG. 15 shows a Modulation Transfer Function curve of the optical system of Embodiment 5. As can be seen from FIGS. 14A to 14C and FIG. 15, the optical system provided in Embodiment 5 can achieve good imaging quality.

Table 11 provides the basic parameters for each of Embodiments 1 to 5, such as the values of f, f1, f2, f3, f4, EPD, TD, TTL, fz1, fz2, SAG11, SAG12, SAG41, BFL, ET3, and FOV.

TABLE 11

| | Embodiment | | | | |
|---|---|---|---|---|---|
| Parameter | 1 | 2 | 3 | 4 | 5 |
| f(mm) | 42.00 | 42.00 | 42.00 | 41.50 | 41.50 |
| f1(mm) | 60.68 | 32.00 | 120.50 | 85.14 | 100.00 |
| f2(mm) | 143.65 | 79.62 | 500.00 | 191.39 | 200.00 |
| f3(mm) | −99.13 | −63.48 | −207.14 | −114.15 | −146.25 |
| f4(mm) | 61.68 | −28.43 | 39.51 | 32.78 | 38.83 |
| EPD(mm) | 23.00 | 23.00 | 23.00 | 23.00 | 23.00 |
| TD(mm) | 24.74 | 24.74 | 25.74 | 24.83 | 24.94 |
| TTL(mm) | 27.00 | 27.00 | 28.00 | 27.00 | 27.00 |
| fz1(mm) | 44.53 | 25.09 | 98.48 | 60.94 | 68.81 |
| fz2(mm) | 140.51 | −18.56 | 48.18 | 45.10 | 52.04 |
| SAG11(mm) | 5.17 | 6.14 | 4.10 | 4.80 | 4.58 |
| SAG12(mm) | 1.92 | 0.43 | 2.33 | 2.20 | 2.38 |
| SAG41(mm) | 0.58 | −0.85 | 1.59 | 1.16 | 0.90 |
| BFL(mm) | 2.26 | 2.26 | 2.26 | 2.17 | 2.06 |
| ET3(mm) | 6.83 | 8.26 | 1.62 | 1.76 | 1.62 |
| FOV(°) | 17.46 | 17.48 | 17.46 | 17.66 | 17.66 |

Table 12 summarizes the values of the conditional Formulas for each of Embodiments 1 to 5.

TABLE 12

| Conditional | Embodiment | | | | |
|---|---|---|---|---|---|
| Formula | 1 | 2 | 3 | 4 | 5 |
| f1/f2 | 0.42 | 0.40 | 0.24 | 0.44 | 0.50 |
| fz1/\|R1 + R4\| | 0.86 | 1.16 | 0.45 | 0.84 | 0.91 |
| R5/f3 | 0.45 | 0.80 | 0.24 | 0.35 | 0.33 |
| (CT2 + CTR + CTQ1)/CT1 | 0.59 | 0.82 | 0.61 | 0.60 | 0.65 |
| f4/fz2 | 0.44 | 1.53 | 0.82 | 0.73 | 0.75 |
| TD/(f × tan(FOV)) | 1.87 | 1.87 | 1.95 | 1.88 | 1.89 |
| V1/N1 | 40.76 | 37.52 | 47.29 | 47.16 | 47.16 |
| R7/f4 | 0.86 | 0.75 | 0.52 | 0.86 | 0.86 |
| TTL/f | 0.64 | 0.64 | 0.67 | 0.65 | 0.65 |
| R1/(SAG11 + SAG12) | 2.84 | 2.76 | 3.68 | 3.03 | 3.16 |
| \|SAG41\|/CT4 | 0.31 | 0.66 | 0.55 | 0.47 | 0.41 |
| BFL/(CTQ2 + CTL) | 9.04 | 9.04 | 9.04 | 8.67 | 8.24 |
| CT3/ET3 | 0.93 | 0.94 | 0.80 | 0.74 | 0.80 |
| ΣCT/EPD | 0.66 | 0.94 | 0.39 | 0.43 | 0.39 |
| f/R2 | 0.91 | 0.21 | 1.11 | 1.02 | 1.10 |

The present application also provides an optical device, which can be a standalone projection device such as a projector, or a projection module integrated into a mobile electronic device such as a virtual reality device. This optical device is equipped with the optical system described above.

The above description merely provides preferred embodiments of the present application and explanations of the technical principles employed. Those skilled in the art should understand that the scope of disclosure involved in the present application is not limited to technical solutions formed by specific combinations of the above technical features. It should also cover other technical solutions formed by any combination of the above technical features or their equivalent features without departing from the inventive concept. For example, technical solutions formed by mutually replacing the above features with technical features having similar functions disclosed (but not limited to) in the present application.

What is claimed is:

1. An optical system, sequentially comprising along an optical axis from a first side to a second side:
a first lens with positive refractive power, having a convex first side surface and a concave second side surface;
a second lens with positive refractive power, having a planar first side surface and a convex second side surface;
a third lens with negative refractive power, having a concave first side surface; and
a fourth lens with refractive power, having a planar second side surface;
wherein, the optical system further comprises:
a first quarter-wave plate, arranged on the first side surface of the second lens;
a reflective polarizing element, arranged on the first side surface of the first quarter-wave plate;
a partially reflective element, arranged on the second side surface of the third lens;
a second quarter-wave plate, arranged on the second side surface of the fourth lens; and
a polarizer, arranged on the second side surface of the second quarter-wave plate;
the number of lenses with refractive power in the optical system is four;
the effective focal length f1 of the first lens and the effective focal length f2 of the second lens satisfy: 0.2<f1/f2≤0.5;
the combined focal length fz1 of the first lens, the reflective polarizing element, the first quarter-wave plate and the second lens, the radius of curvature R1 of the first side surface of the first lens, and the radius of curvature R4 of the second side surface of the second lens satisfy: 0.4<fz1/|R1+R4|<1.2.

2. The optical system according to claim 1, wherein the radius of curvature R5 of the first side surface of the third lens and the effective focal length f3 of the third lens satisfy: 0.2<R5/f3≤0.8.

3. The optical system according to claim 1, wherein the center thickness CT1 of the first lens on the optical axis, the center thickness CTR of the reflective polarizing element on the optical axis, the center thickness CTQ1 of the first quarter-wave plate on the optical axis, and the center thickness CT2 of the second lens on the optical axis satisfy: 0.5<(CT2+CTR+CTQ1)/CT1<0.9.

4. The optical system according to claim 1, wherein the effective focal length f4 of the fourth lens and the combined focal length fz2 of the third lens, the fourth lens, the second quarter-wave plate and the polarizer satisfy: 0.4<f4/fz2<1.6.

5. The optical system according to claim 1, wherein the Abbe number V1 of the first lens and the refractive index N1 of the first lens satisfy: 37.5<V1/N1<47.3.

6. The optical system according to claim 1, wherein the radius of curvature R7 of the first side surface of the fourth lens and the effective focal length f4 of the fourth lens satisfy:
0.5<R7/f4<0.9.

7. The optical system according to claim 1, wherein the axial distance SAG11 from the intersection of the first side surface of the first lens and the optical axis to the effective semi-aperture vertex of the first side surface of the first lens, and the axial distance SAG12 from the intersection of the second side surface of the first lens and the optical axis to the effective semi-aperture vertex of the second side surface of the first lens, and the radius of curvature R1 of the first side surface of the first lens satisfy: 2.7<R1/(SAG11+SAG12)<3.7.

8. The optical system according to claim 1, wherein the axial distance SAG41 from the intersection of the first side surface of the fourth lens and the optical axis to the effective semi-aperture vertex of the first side surface of the fourth lens and the center thickness CT4 of the fourth lens on the optical axis satisfy: 0.3<|SAG41|/CT4<0.7.

9. The optical system according to claim 1, wherein the center thickness CT3 of the third lens on the optical axis and the edge thickness ET3 of the third lens satisfy: 0.7<CT3/ET3<1.0.

10. The optical system according to claim 1, wherein the axial distance TD from the first side surface of the first lens to the second side surface of the fourth lens, the total effective focal length f of the optical system, and the maximum field of view FOV of the optical system satisfy: 1.8<TD/(f×tan(FOV))<2.0.

11. The optical system according to claim 1, wherein an imaging surface is provided on the second side of the optical system, and the axial distance TTL from the first side surface of the first lens to the imaging surface and the total effective focal length f of the optical system satisfy: 0.6<TTL/f<0.7.

12. The optical system according to claim 1, wherein an imaging surface is provided on the second side of the optical system, and the axial distance BFL from the second side surface of the fourth lens to the imaging surface, the center thickness CTQ2 of the second quarter-wave plate on the optical axis, and the center thickness CTL of the polarizer on the optical axis satisfy: 8.2<BFL/(CTQ2+CTL)<9.1.

13. The optical system according to claim 1, wherein the sum of the center thicknesses ΣCT of the first lens, the second lens, the third lens, and the fourth lens on the optical axis and the entrance pupil diameter EPD of the optical system satisfy: 0.3<ΣCT/EPD<1.0.

14. The optical system according to claim 1, wherein the total effective focal length f of the optical system and the radius of curvature R2 of the second side surface of the first lens satisfy: 0.2<f/R2<1.2.

15. The optical system according to claim 2, wherein the axial distance TD from the first side surface of the first lens to the second side surface of the fourth lens, the total effective focal length f of the optical system, and the maximum field of view FOV of the optical system satisfy: 1.8<TD/(f×tan(FOV))<2.0.

16. The optical system according to claim 2, wherein an imaging surface is provided on the second side of the optical system, and the axial distance TTL from the first side surface of the first lens to the imaging surface and the total effective focal length f of the optical system satisfy: 0.6<TTL/f<0.7.

17. The optical system according to claim 2, wherein an imaging surface is provided on the second side of the optical system, and the axial distance BFL from the second side surface of the fourth lens to the imaging surface, the center thickness CTQ2 of the second quarter-wave plate on the optical axis, and the center thickness CTL of the polarizer on the optical axis satisfy: 8.2<BFL/(CTQ2+CTL)<9.1.

18. The optical system according to claim 2, wherein the sum of the center thicknesses ΣCT of the first lens, the second lens, the third lens, and the fourth lens on the optical axis and the entrance pupil diameter EPD of the optical system satisfy: 0.3<ΣCT/EPD<1.0.

19. The optical system according to claim 2, wherein the total effective focal length f of the optical system and the radius of curvature R2 of the second side surface of the first lens satisfy: 0.2<f/R2<1.2.
